(19) United States
(12) Patent Application Publication
(10) Pub. No.: US 2025/0371747 A1
(43) Pub. Date: Dec. 4, 2025

(54) SYSTEMS AND METHODS FOR COORDINATED OUTPUT OF A VISUAL EFFECT FOR ENHANCED AUDIENCE ENGAGEMENT AT A LIVE EVENT

(71) Applicant: Adeia Guides Inc., San Jose, CA (US)

(72) Inventors: Ning Xu, Irvine, CA (US); Toshiro Ozawa, Irvine, CA (US); Charles Dasher, Lawrenceville, GA (US); Cato Yang, San Jose, CA (US); Aldis Sipolins, Somerville, MA (US)

(21) Appl. No.: 18/680,870

(22) Filed: May 31, 2024

(51) Int. Cl. G06T 11/00; G06T 7/90

(52) U.S. Cl. CPC G06T 11/00; G06T 7/90; G06T 2200/24; G06T 2207/30244

(57) ABSTRACT

Systems and methods for coordinated output of an visual effect at a live event are described herein. A plurality of devices at a live event are identified. For each device of the plurality of devices, a current position of the device within the venue of the live event is determined. The current position of the device is determined by determining an initial location of the device and tracking, during a time period, a position of the respective device within the venue relative to the initial location using data from one or more sensors (e.g., accelerometers, gyroscopes, or any other suitable sensors). The current position of the device is recalibrated by causing the device to capture an image and analyzing the captured image. Based on the determined current positions of the plurality of devices, signals that are coordinated to form an visual effect are output on the plurality of devices.

### BACKGROUND

The present disclosure is directed to systems and methods for enhancing audience engagement at a live event by coordinating or synchronizing output (e.g., a visual output, effect, or animation) by a plurality of devices at the live event. Techniques are disclosed for tracking a real-time location of devices within a venue or event space, and coordinating output, e.g., of a large-scale animation, by the devices based at least in part on the tracked real-time location.

### SUMMARY

Live events (e.g., concerts or sports games) at venues such as stadiums or arenas are often attended by tens of thousands of spectators. Traditionally, during many such live events, spectators wish to engage with the event, showing support for their favorite performers or sports teams. For example, spectators often wear team colors during a basketball game, or wave their smartphone flashlights in the air during a concert.

Modern advances in smartphone or mobile device technology have increased the possibilities for audience engagement during such live events. Given that most people carry their smartphones with them everywhere they go, at a live event attended by tens of thousands of spectators, there are likely tens of thousands of mobile devices within the venue at any given point during the live event. As a result, smartphones can be relied upon to facilitate widespread audience engagement beyond traditional methods, such as asking audience members to participate in a coordinated action, such as the wave, or a cheer prompted by a jumbotron at the venue, such as “Defense! Defense! Defense!”

In one approach, a seat number indicated on a ticket stub can be used to determine locations of users, and content related to the live event can be displayed on devices of those users. However, relying on ticket stub information to identify a location of a user in a large event venue, as in the above-mentioned approach, is often insufficient. For example, users often leave their seats to go to the restroom or stop by the concession stand or might have general admission floor seats or standing room only seats, and the position of the user within the venue is not static. Such changing audience locations therefore make it difficult to output a coordinated or synchronized output across devices at the venue in real-time. For example, in the above-mentioned approach, since the system is unaware that those spectators have moved away from their ticketed seats, the resulting display might be very fragmented and incoherent due to the absence of the mobile devices corresponding to these spectators that are away from their ticketed seats.

Furthermore, in the above-mentioned approach, mobile devices corresponding to spectators who are not participating in the distributed display may still be caused to output content, since the system in such approach is unaware that those spectators are not participating in the distributed display. For example, the system may cause devices of spectators who have left their ticketed seat to use the bathroom or to grab a snack to nonetheless provide an output related to a distributed effect, which wastes unnecessary bandwidth and/or processing or battery power, as such output may merely be performed while a device is in the pocket of the user, and thus not contributing to the distributed display of content in the venue. Such challenges are only amplified at events that do not have assigned seating, as spectators are constantly moving around the venue. As such, there is a desire for an efficient manner of accurately tracking real-time locations of audience members in the venue, to enable synchronizing output based on the current positions of the devices in the venue and to enable dynamically modifying the output based on the current positions of the devices.

To help address these problems, systems, apparatuses, and methods are disclosed herein for identifying a plurality of devices at a live event. In some embodiments, the system determines, for each respective device of the plurality of devices at a live event, a current position of the respective device within a venue of the live event by determining an initial position of the respective device and tracking, using data from one or more sensors (e.g., accelerometers, gyroscopes, or any other suitable sensors), a position of the respective device within the venue relative to the initial position. In some embodiments, the system performs recalibration of the current position by causing the respective device to capture an image and analyzing the captured image. In some embodiments, based on the determined current position of the plurality of devices, the system causes the plurality of devices to output signals that are coordinated to form a visual effect.

Such aspects enable a coordinated display distributed across a plurality of devices to be output on the plurality of devices, and dynamically modified based on the real-time locations of each device. For example, such aspects enable precise locations of each device in the venue (e.g., an arena or stadium) to be tracked in real-time, to enable output of signals (e.g., images, video, lights, audio, haptic feedback, etc.) from the plurality of devices that together form an visual effect or other visual, audio, haptic, or other multimedia effect. As another example, such aspects enable the displayed visual effect to be modified based on the live location data, thus allowing for the visual effect to dynamically adapt to the live movements of the audience. Furthermore, as another example, such aspects enable output to be stopped while a device is in the pocket of the user and thus not contributing to the distributed display of content in the venue, thus preventing unnecessary bandwidth and/or processing or battery power from being wasted. Such aspects also enable images of the venue to be captured at certain intervals, which saves resources such as battery life and memory while also minimizing privacy concerns associated with constant image capture from the device's camera.

In some embodiments, the techniques described herein provide a comprehensive system to transform individual smartphones in a large venue into a coordinated, dynamic and adaptive display network. In some embodiments, such a system leverages localization techniques, including one or more of GPS, Wi-Fi, Bluetooth, peer-to-peer communication, and techniques for analyzing images taken by the devices themselves, to track the precise location of each smartphone within the venue in real-time during usage. In some embodiments, the precise and real-time localization allows these devices to be orchestrated to function collectively as pixels in a larger display, enabling the presentation of visual effects, text, or other visual content across thousands of screens simultaneously. Moreover, in some embodiments, the system can control various outputs of the smartphones, such as LED flashlights, LCD/OLED screens, audio, and vibrators, to create immersive and coordinated special effects integrating comprehensive real-time localization, dynamic content delivery, and interactive audience participation into a unified system. In some embodiments, the system supports a broad range of output effects (e.g., static images, animations, text, audio effects, haptic feedback, interactive features, etc.), and integrates with venue infrastructure for a holistic event experience, which creates immersive environments that actively respond to and engage with the audience, enhancing audience participation and experience at large-scale events.

In some embodiments, the identifying the plurality of devices at the live event further comprises receiving, from the plurality of devices, a user interface input requesting to participate in the coordinated visual effect.

In some embodiments, the signals that are coordinated to form the visual effect are output via a flashlight of the respective device. In some embodiments, the signals that are coordinated to form the visual effect are output via a screen of the respective device, such that the screen of the respective device comprises one or more pixels of the visual effect. In some embodiments, performing the recalibration further comprises causing at least a first device and a second device of the plurality of devices to communicate via peer-to-peer communication to identify a current position of the first device relative to a current position of the second device. Furthermore, in some embodiments, the causing the plurality of devices to output the signals that are coordinated to form the visual effect by causing the screen of the respective device to correspond to one or more pixels of the visual effect is based at least in part on the current position of the first device relative to a current position of the second device. In some embodiments, the system causes the plurality of devices to output audio along with the signals that are coordinated to form the visual effect.

In some embodiments, the captured image is a first captured image, and determining the initial position of the respective device further comprises causing the respective device to capture a second image of at least a portion of the venue of the live event, comparing the second image to a spatial representation of the venue, and determining the initial position of the respective device based on the comparison.

In some embodiments, the system tracks, during the time period, the position of the respective device relative to the initial position using the one or more sensors by tracking changes in at least one of an acceleration, a rotational position or an orientation of the respective device.

In some embodiments, the system analyzes the captured image by comparing the captured image to a spatial representation of the venue, and the performing the recalibration of the current position includes updating the current position of the respective device within the venue of the live event based on the comparison.

In some embodiments, the system performs the recalibration of the current position by causing the respective device to capture the image by monitoring a stability level of the respective device, wherein the stability level is based on at least one of an acceleration, a rotational position, or an orientation of the respective device, determining that the stability level indicates that the device is stable, and causing the respective device to capture the image based on determining that the stability level of the respective device indicates that the device is stable. In some embodiments, the system causes the plurality of devices to output the signals that are coordinated to form the visual effect by monitoring a stability level of the respective device, wherein the stability level is based on at least one of an acceleration, a rotational position, or an orientation of the respective device. In some embodiments, the system, based on the monitoring, determines a state corresponding to the respective device, wherein an active state specifies that the respective device is currently available to output the signals, and wherein an inactive state specifies that the respective device is currently unavailable to participate in output of the signals that are coordinated to form the visual effect.

In some embodiments, the system causes the plurality of devices to output the signals that are coordinated to form the visual effect by determining a density of a section of the venue, wherein the density specifies a number of devices associated with the active state that are concentrated within the section of the venue and selecting the visual effect based on the density.

In some embodiments, the system determines an updated density for the section of the venue based on detecting a change in the density of the section of the venue, selects a different visual effect based on the updated density, and outputs signals that are coordinated to form the different visual effect on devices specified as having the active state in association with the updated density in the section of the venue.

In some embodiments, the system, based on determining that at least one device of the plurality of devices participating in the output of the signals that are coordinated to form the visual effect has changed from the active state to the inactive state, transmits a notification to the at least one device prompting the at least one device to participate in output of the signals that are coordinated to form the visual effect. In some embodiments, the system outputs, at the respective device, an indication directing a user to position or move the respective device in a particular manner to form the visual effect.

In some embodiments, the system determines a characteristic corresponding to a user of the respective device and modifies the signals outputted by the respective device based on the determined characteristic.

In some embodiments, the plurality of devices are associated with a plurality of spectators at the venue, and one or more cameras in the venue are configured to capture a plurality of images of the plurality of spectators. In some embodiments, determining the initial position of the respective device further comprises causing the respective device to output an initial output that comprises a pattern unique to the respective device, identifying portions of the plurality of images which depict the initial output, and determining the initial position of the respective device based at least in part on the portions of the plurality of images that depict the initial output.

In some embodiments, the system identifies device capabilities corresponding to the respective device and selects the signals to output on the respective device based on the device capabilities corresponding to the respective device.

In some embodiments, the system determines a density of devices with a particular capability within a section of the venue, wherein the density specifies a number of devices associated with the particular capability that are concentrated within the section of the venue, and selects the visual effect based on the density of devices with the particular capability.

In some embodiments, indications from a plurality of devices at a live event are received, by the server. In some approaches, the server determines, for each respective device of the plurality of devices at the live event, a current position of the respective device within a venue of the live event by determining, based on data received from the plurality of devices, an initial position of the respective device, and tracking, based on data from one or more sensors received by the server from the plurality of devices, a position of the respective device within the venue relative to the initial position. In some embodiments, the server performs recalibration of the current position by transmitting an indication to the respective device to capture an image and analyzes the captured image. In some embodiments, based on the determined current positions of the plurality of devices, indications are transmitted to the plurality of devices to output signals that are coordinated to form a visual effect.

### BRIEF DESCRIPTION OF DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1A is a schematic example of causing coordinated output of an visual effect at a live event, in accordance with embodiments of the disclosure.

FIG. 1B is a continuation of FIG. 1A, and provides a schematic example of causing coordinated output of an visual effect at a live event, in accordance with embodiments of the disclosure.

FIG. 1C is continuation of FIGS. 1A and 1B, and provides a schematic example of

causing coordinated output of an visual effect at a live event, in accordance with embodiments of the disclosure.

FIG. 2 shows an illustrative technique for tracking the precise location of a device, in accordance with embodiments of the disclosure.

FIG. 3 shows an illustrative technique for identifying the precise location of a device and executing output of signals to form an visual effect, in accordance with embodiments of the disclosure.

FIG. 4 shows an illustrative technique for causing coordinated output of an visual effect at a live event, in accordance with embodiments of the disclosure.

FIG. 5A is a schematic example of transmitting a notification to a device in relation to coordinated output of an visual effect, in accordance with embodiments of the disclosure.

FIG. 5B is a schematic example of transmitting a notification to a device in relation to coordinated output of an visual effect, in accordance with embodiments of the disclosure.

FIG. 6 is a schematic illustration of modifying the density of an visual effect at a live event, in accordance with embodiments of the disclosure.

FIG. 7 is a schematic illustration of causing coordinated output of an visual effect at a live event based on received user inputs, in accordance with embodiments of the disclosure.

FIG. 8 shows illustrative devices and systems for causing coordinated output of an visual effect at a live event, in accordance with some embodiments of this disclosure.

FIG. 9 shows illustrative devices and systems for causing coordinated output of an visual effect at a live event, in accordance with some embodiments of this disclosure.

FIG. 10 is a flowchart of a detailed illustrative process for tracking the precise location of a device, in accordance with some embodiments of this disclosure.

FIG. 11 is a flowchart of a detailed illustrative process for causing coordinated output of an visual effect at a live event, in accordance with some embodiments of this disclosure.

### DETAILED DESCRIPTION

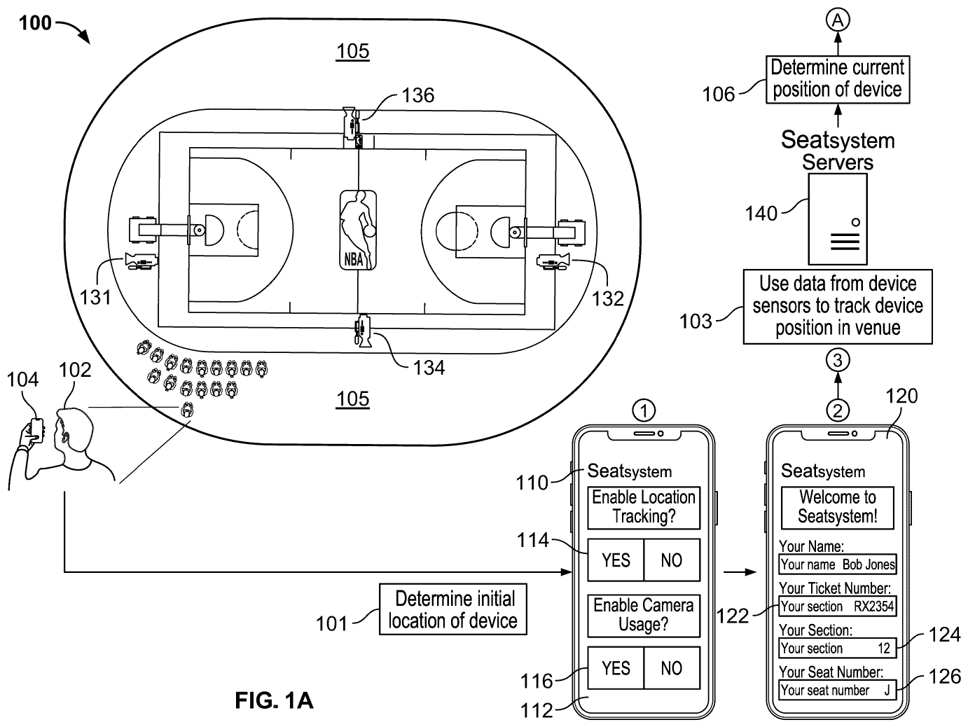

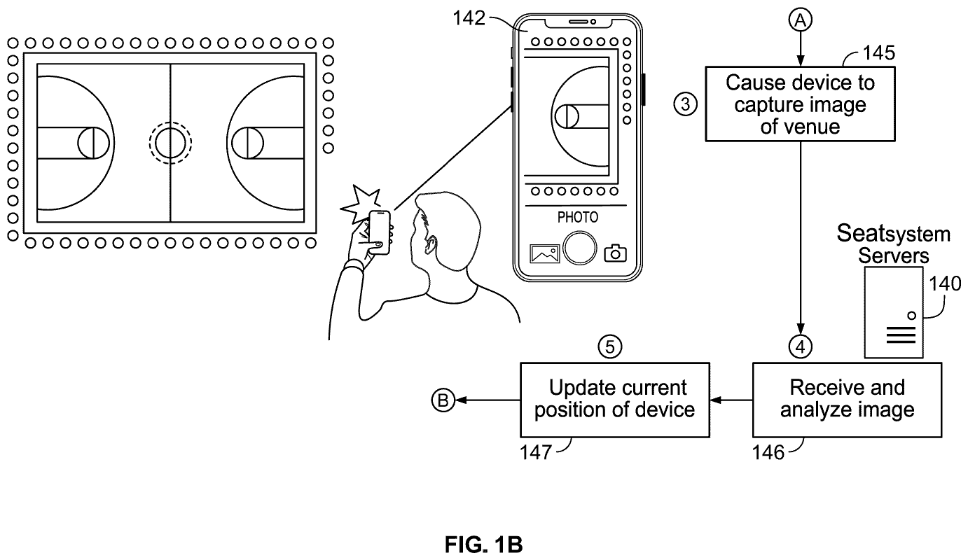

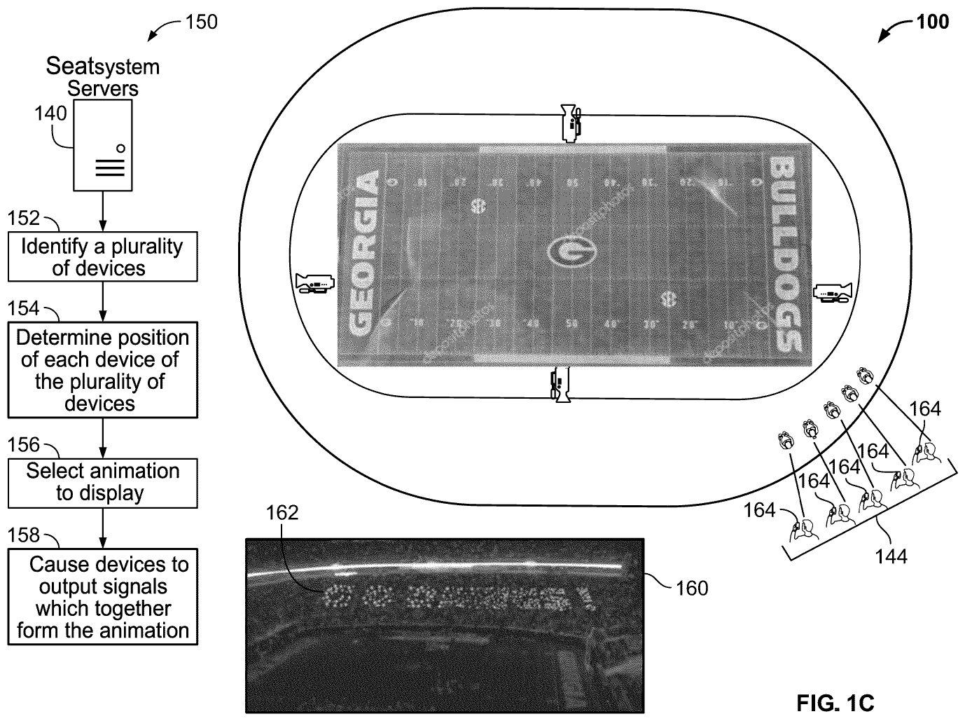

FIGS. 1A, 1B, and 1C depict examples of causing coordinated output of a visual effect at a live event, in accordance with embodiments of the disclosure. While in the examples of FIGS. 1A, 1B, and 1C, the live event is depicted as a basketball game at a basketball arena, stadium, or gym 100, it should be appreciated that the present disclosure is applicable to any suitable live event, e.g., a professional or collegiate or other level of a sporting event, such as, for example, a football game, a baseball game, a hockey game, a soccer match, a tennis match, a golf tournament, or the Olympics, or any other suitable sporting event, or any combination thereof; a concert; a play or theater or drama performance; a political debate or rally; a video game tournament; or any other suitable event at any suitable venue; or any combination thereof.

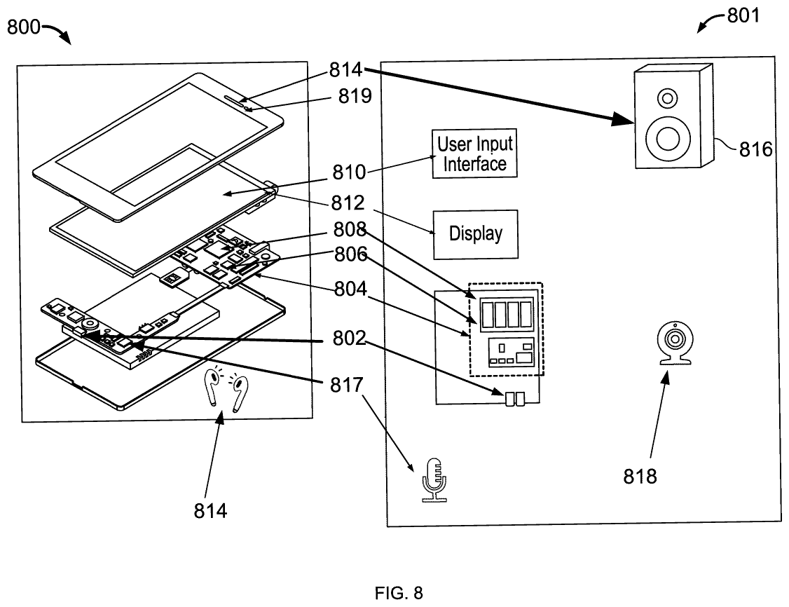

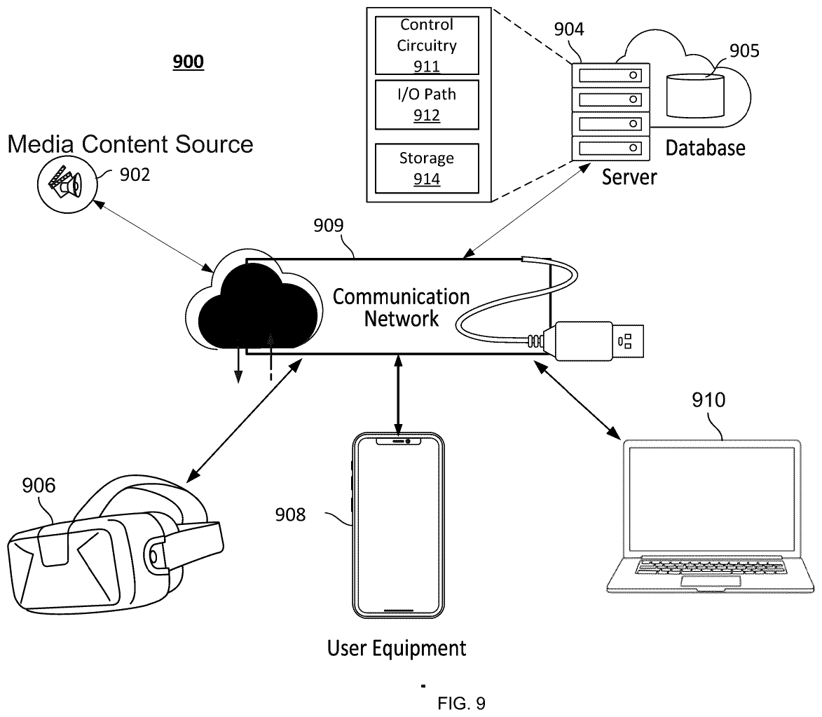

As shown in FIG. 1A, a viewer or user 102 may be present in spectator area 105 at the live event, along with a plurality of other users or viewers (e.g., thousands of other audience members at the live event). User 102 may be using and/or be associated with user equipment 104. User equipment 104, which in some examples corresponds to user equipment 800 of FIG. 8 and user equipment 908 of FIG. 9, may comprise or correspond to a mobile device such as, for example, a smartphone or tablet; a laptop; a smart watch or wearable device; smart glasses; a stereoscopic display; a wearable camera, extended reality (XR) glasses; XR goggles; an XR head-mounted display (HMD); near-eye display device; or any other suitable user equipment or computing device; or any combination thereof. In some embodiments, user equipment 104 may be brought to the live event by user 102 and owned by user 102 or may be provided to user 102 by the organization hosting the live event for use at the live event, e.g., may be present at each seat of the audience members, or may correspond to any other suitable user equipment. FIGS. 1A-1C depict aspects of the process for localizing user equipment 104, and techniques that can be used for any suitable number of devices in venue 100 simultaneously or at any suitable other desired times.

XR may be understood as virtual reality (VR), augmented reality (AR) or ‘mixed reality (MR) technologies, or any suitable combination thereof. VR systems may project images to generate a three-dimensional environment (3D) to fully immerse (e.g., giving the user a sense of being in an environment) or partially immerse (e.g., giving the user the sense of looking at an environment) users in a 3D, computer-generated environment. Such environment may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with the real world or the real world is otherwise connected to virtual objects.

In some embodiments, a localization and animation coordination (LAC) application (e.g., an application of Seat system service 110) may be executed at least in part on user equipment 104 and/or at one or more remote servers and/or at or distributed across any of one or more other suitable computing devices, in communication over any suitable number and/or types of networks (e.g., the Internet). The LAC application may be configured to perform the functionalities (or any suitable portion of the functionalities) described herein. In some embodiments, the LAC application may be a stand-alone application, or may be incorporated as part of any suitable application, e.g., one or more broadcast content provider applications, broadband provider applications, live content provider applications, media asset provider applications, XR applications, video or image or electronic communication applications, social networking applications, image or video capturing and/or editing applications, or any other suitable application(s), sports teams, clubs, organizations or leagues (e.g., the National Football League or the English Premier League or any other suitable league) or any combination thereof.

In some embodiments, the LAC application may be installed at or otherwise provided to a particular computing device, may be provided via an application programming interface (API), or may be provided as an add-on application to another platform or application. In some embodiments, software tools (e.g., one or more software development kits, or SDKs) may be provided to any suitable party, to enable the party to implement the functionalities described herein.

As shown in FIG. 1A, the LAC application, in some embodiments, causes user equipment 104 to generate for display user interface 112. In some implementations, user interface 112 comprises user-selectable options 114 and 116, which prompt user input corresponding to location and camera usage permissions. For example, the LAC application receives a selection of user-selectable option 114 (e.g., a selection of the “YES” option) that indicates that the LAC application is allowed to access the device's location and a selection of user-selectable option 116 (e.g., a selection of the “YES” option) that indicates that the LAC application is allowed to access the device's camera. In some embodiments, the LAC application user interface 112 comprises additional user selectable options prompting input related to additional permissions, such as microphone access, notification display, Bluetooth access, and/or any other suitable permissions. Input may be received in any suitable form, e.g., as voice input, tactile input, input received via a keyboard or remote, input received via a touchscreen, text-based input, biometric input, or any other suitable input, or any combination thereof. In some embodiments, the LAC application may automatically begin using the camera and/or location tracking system of user equipment 104 or may receive permission to do so at an earlier time (e.g., when the LAC application is downloaded to user equipment 104).

In some embodiments, at step 101, the LAC application determines an initial location of the device. In some embodiments, the LAC application may identify a seat location or other indication of a location of user 102 within spectator area 105 or another portion of venue 100. For example, the LAC application may cause user equipment 104 to generate for display user interface 120, which prompts input identifying the initial location of the device. User interface 120 may be provided to user equipment device 104 prior to user interface 112 being provided to user equipment device 104, after user interface 112 is provided to user equipment device 104, or the options of user interface 112 may be provided simultaneously with the options of user interface 112. In some embodiments, user interface 120 comprises an indication 122 prompting user 102 to provide a ticket number or confirmation code associated with purchase of their ticket (e.g., confirmation code “RX2354”). Additionally, or alternatively, the LAC application may access a camera of user equipment 104, to capture an image of a bar code of a physical ticket (or obtain a screenshot including a bar code of an electronic ticket), to identify a seat of user 102.

In some embodiments, the LAC application, upon receiving input identifying a ticket number or confirmation code corresponding to user 102, retrieves a digital ticket associated with the ticket number or confirmation code and identifies a seat number corresponding to the digital ticket. In some embodiments, there may be more than one ticket associated with a confirmation code, and as such, the LAC application may request further input that identifies which of the digital tickets corresponds to user 102. In some embodiments, the LAC application requests input identifying a seat number and/or a section corresponding to user 102 (e.g., via user-selectable options 124 and 126, respectively). In some embodiments, the LAC application permits user 102 to identify multiple users (e.g., friends attending the live event with user 102) having tickets or otherwise being present near user 102 at venue 100, and/or send invites to download the LAC application and/or join a group for the live event, which may help the LAC application associated devices of users with certain seat numbers or other locations.

In some embodiments, the LAC application receives the initial location of device 104 via an image captured by the camera of the device. For example, the LAC application may cause user equipment device 104 to generate for display a user interface that prompts user 102 to capture or upload an image of at least a portion of the venue. In some embodiments, the LAC application automatically causes device 104 to capture an image of the venue, e.g., upon detecting that the user's location corresponds to venue 100 or upon detecting that the user has accessed the LAC application. In some implementations, the LAC application, upon receiving the image, compares the received image to a spatial representation of the venue to determine the device's initial location. In some embodiments, the LAC application sends the received images to one or more servers (e.g., server 140, which, in some examples, corresponds to server 904 of FIG. 9), and the LAC application compares the received image to a spatial representation (e.g., a 3D representation of the venue, images captured by external cameras, or any other suitable spatial representation) of venue 100 to determine the user equipment device's 104 initial location.

In some embodiments, the LAC application, upon receiving the initial location of the device, sends the initial location to one or more servers (e.g., server 140 of the LAC application, which, in some examples, corresponds to server 904 of FIG. 9). At step 103, the LAC application, in some embodiments, receives data from device sensors to track the device's position within the venue. In some embodiments, the sensors comprise one or more of accelerometers, gyroscopes, a global positioning system (GPS) system, an indoor positioning system, magnometers, and/or any other suitable sensors or positioning systems, used to monitor the device's movements in terms of acceleration, rotational changes, and/or orientation. The sensors, in some embodiments, are part of inertial measurement units (IMUs) of user equipment device 104.

As an example, the LAC application may receive input that identifies that the initial location of device 104 is seat J of section 12. In some situations, user 102 of device 104 may not stay in that assigned seat (or may not have an assigned seat), and in order to track the movement of user 102, the LAC application receives data from device sensors (and/or other data, such as, for example, images captured by camera 131, 132, 134, 136 or any other suitable data) in order to track the position and movements of device 104. For example, if user 102 puts device 104 in their pocket after holding it up in the air for a period of time, the sensors of device 104 may detect a change in the device's orientation, and based on the detected change, the LAC application may receive data from device 104 indicating a change in the device's orientation. Similarly, if user 102 walks to the concession stand or restroom or other portion of venue 100, the sensors of device 104 may detect a change in the acceleration and/or position of the device, and the LAC application may receive data from device 104 indicating a change in the acceleration and/or position of device 104. In some embodiments, at step 106, the LAC application, based on the determined initial location of the device and the data from the device sensors, determines the current position of the device within the venue. In some embodiments, the current position of user equipment device 104 and/or other devices within venue 100 may be tracked for any suitable time period, e.g., for the duration of the live event, and/or when the LAC application is open or otherwise has permission to track the users. In some embodiments, camera 131, 132, 134, 136 may be stationary or movable cameras (e.g., drones or an aerial camera) used to capture the live event from various perspectives for a broadcast or stream of the live event.

As shown in FIG. 1B, in some embodiments, the LAC application performs recalibration of the current position of the device within venue 100 to correct any errors accumulated by the sensor data over time. In some embodiments, the LAC application performs the recalibration by, at step 145, causing device 104 to capture one or more images (e.g., image 142) automatically and/or by prompting user 102 to capture such image(s). The LAC application, in some implementations, sends the captured image(s) to one or more servers (e.g., server 140). At step 146, the LAC application, in some embodiments, analyze the received image to recalibrate the position of device 104, correcting any errors accumulated over time in the sensor and/or position data.

In some embodiments, the LAC application, based on or in response to receiving data from the sensors of device 104 that indicates a high likelihood for errors in the sensor data (e.g., the sensor data indicates an improbable degree of change in the acceleration and/or position of the device), causes device 104 to capture an image. In some implementations, the LAC application causes device 104 to capture an image at certain time intervals (e.g., every 20 minutes, or any other suitable time interval). In some embodiments, the LAC application causes device 104 to capture an image when certain conditions are met. For example, the LAC application may detect that a condition is met by monitoring a stability level of device 104 based on data received from the sensors of device 104 (e.g., with respect to the device's acceleration, rotational position, or orientation). In some such examples, the LAC application causes device 104 to capture the image based on monitoring the stability level of device 104 and, based on such stability level, detecting that device 104 is stable enough to capture an image, e.g., based on the stability level being above or below a threshold. As another example, the LAC application may capture images at an optimal time, e.g., when the weather permits, such as if it stops raining in the venue, and/or when the user is moving more slowly or is stationary.

In some examples, the LAC application receives and analyzes the captured image(s). Any suitable technique may be used to analyze the captured image. For example, the LAC application may employ machine learning and/or heuristic techniques in real time to analyze the captured image. In some embodiments, a naïve thresholding technique, an image segmentation technique, a computer vision technique, an image processing technique, or any other suitable technique, or any combination thereof may be used to identify one or more objects within the captured image. In some embodiments, an image processing system may utilize one or more machine learning models (e.g., naive Bayes algorithm, logistic regression, recurrent neural network, convolutional neural network (CNN), bi-directional long short-term memory recurrent neural network model (LSTM-RNN), or any other suitable model, or any combination thereof) to localize and/or classify objects in a given image.

As an example, the LAC application, after receiving the one or more images captured by the device 104 (e.g., depicting at least a portion of venue 100 of the live event), analyzes the image(s) using image processing techniques and determine that the image depicts a portion of the live event. In some examples, the LAC application analyzes the received image by comparing it to a spatial representation of the venue. In some implementations, the LAC application uses the comparison to determine which portion of the venue the received image depicts. In another example, the LAC application, may perform at least a portion of the analysis of the captured image using one or more image processing techniques and compares it to a spatial representation of the venue.

In some embodiments, the LAC application determines whether the device is available to participate in output of signals that are coordinated to form a visual effect based on analysis of the received image. In some cases, the LAC application causes the device to capture an image that does not provide any information that helps with the recalibration of the device's current position. For example, the captured image might depict a floor or a ceiling of the venue, or might not depict anything at all (e.g., if the device is in the user's pocket), and as such, analysis of the captured image does not provide any information that helps in identifying where the device is located, and therefore indicates that the device is not available to participate in output of signals that are coordinated to form a visual effect. In some examples, the LAC application, based on receiving an image that does not help in performing recalibration of the device's current position, causes a notification to be transmitted to the device (e.g., via an on-screen message, haptic feedback, and/or any other suitable notification method) which directs the user of the device to hold the device in a particular manner that is best suited for image capture.

In some implementations, the LAC application, based on or in response to receiving data from the sensors of device 104 (and/or based on sensor data received from a source other than device 104) that indicates that device 104 is not stable (e.g., the data indicates that a stability level of the device is above or below a threshold), causes device 104 to capture an image. For example, the LAC application may detect that device 104 is unstable based on receiving data indicating that the stability level of device 104 is below a threshold and cause device 104 to capture an image to confirm that the device is moving around or unstable. In some such examples, the LAC application analyzes the captured image and determines that the captured image is blurry (and/or that IMU data is unreliable), and as such, determines that the device is not stable (or is moving from an initial position) and therefore not available to participate in output of signals coordinated to form a visual effect. In some embodiments, the LAC application continues to track the device's position within venue 100 using the sensor data and repeats the recalibration process at a later time, e.g., continuously or periodically.

In some embodiments, the recalibration process comprises causing device 104 to communicate with surrounding devices (e.g., the plurality of devices 164 of FIG. 1C) via peer-to-peer (P2P) communication, in order to identify a current position of the device relative to a current position of a second device. As an example, an LAC application may determine that a first device is located at the concession stand within venue 100 based on establishing a connection with at least one other device also located at the concession stand. In such an example, the LAC application determines that the at least one other device is located at the concession stand and uses the position information of the at least one other device to determine the position of the first device relative to the at least one other device. As another example, devices may use P2P communication techniques to establish their proximity to each other, and/or their locations, within spectator area 105. For example, a group of devices for which a visual effect is to be coordinated may be identified based at least in part using P2P communication, the results of which may be communicated to remote server.

In some embodiments, at step 147, the LAC application updates the current position of the device based on the results of the recalibration process. In some embodiments, after updating the current position of the device, the LAC application continues to track the device's position within the venue using the sensor data using the techniques described herein, e.g., in relation to tracking the device's position and performing recalibration. In some embodiments, the LAC application updates the current position of the device periodically. In some embodiments, the LAC application continuously updates the current position of the device based on the device's tracked movements.

As shown in FIG. 1C, in some embodiments, process 150 for coordinating output on a plurality of devices at the live event begins at step 152, where the LAC application (e.g., via one or more servers 140 of the LAC application) identifies a plurality of devices (e.g., plurality of devices 164) corresponding to participating users (e.g., participating users 144) at the live event. In some embodiments, the plurality of devices may comprise all the devices located within the venue, while in other embodiments, the plurality of devices may comprise a section of the venue, or a small group of devices, such as small group of devices 164. For example, in some embodiments, the LAC application identifies all the devices logged in using the LAC application as part of the plurality of devices. In some embodiments, when the LAC application receives a selection opting into participation in an event, the LAC application initializes the systems and features for enhanced event engagement and establishes a connection with the servers. In a non-limiting example, as shown in FIG. 1C, the live event may be a college football game, e.g., a home game for the University of Georgia NCAA football team at venue 100 of FIG. 1C.

In some embodiments, the LAC application identifies multiple subsets within the plurality of devices. For example, a group of users within the venue (e.g., the group of users seated next to each other 144) may wish to display a personalized sign or visual effect (e.g., a personalized message such as “Throw the ball here,” a birthday message such as “Happy Birthday John,” a message of “Shoot a T-shirt up here,” or any other suitable message or visual effect). For example, such users may all be friends, and the LAC application may receive input from one or more users of the group of users to localize such users and coordinate the visual effect amongst such group of users. In some embodiments, the LAC application displays an option allowing for creation of a group to display a custom image or animation. Selection of the option, in some embodiments, facilitates the creation of a group which can be joined by other devices within the venue. In some embodiments, the LAC application provides, alongside the option allowing for creation of the group, an option for uploading or selecting the visual effect to be output across the devices within the group, and signals coordinated to form the selected animation are output on the devices within the group.

In some embodiments, LAC application executing on the user equipment devices of users present in venue 100 may communicate directly (e.g., via P2P) to establish a group of devices to be used in outputting the visual effect.

In some embodiments, after 152, process 150 moves to step 154, where the LAC application determines the position of each device of the plurality of devices. In some embodiments, the position of each device is determined based on the techniques described e.g., in relation to tracking the position of device, as described at step 106 in FIG. 1A. In some embodiments, the LAC application collects information related to device position and availability to output signals to form a visual effect.

In some embodiments, after 154, process 150 moves to step 156, where the LAC application selects a visual effect to display on the identified plurality of devices. In some implementations, the LAC application selects flickering effects, colors, text, images, and/or animations to output across the plurality of devices. In some embodiments, the LAC application selects a specific section of the venue to use for a rectangular display or use all the sections to create a 360-degree display spanning the entire venue. In some implementations, the LAC application selects the visual effect to display based on the distribution of fans of a particular team. In some examples, a particular section of the venue corresponds to a particular team, and the LAC application selects the visual effect for a section based on the team the section corresponds to. For example, one section of a venue hosting a basketball game is designated for fans of the home team, while another section of the venue is designated for fans of the visiting team, and the LAC application selects an animation cheering for the home team to be displayed in the section designated for fans of the home team.

In other examples, the distinction may not be as clear cut, and in some cases, the LAC application determines the distribution of fans of each team throughout the venue based on responses to questions within the LAC application. In some embodiments, the LAC application generates for display a user interface prompting fans to identify which team they support and communicates the responses to the server(s) 140. In some implementations, the LAC application determines the distribution of fans of each team throughout the venue and selects the visual effect to display in a particular section based on the distribution of fans throughout that section. For example, in the case where a section is comprised of mostly fans of the home team, the LAC application selects an animation cheering on the home team, e.g., text or an image, such as, for example, a mascot, of the home team, or a decibel level animation of audience noise, or any other suitable visual effect.

In some embodiments, the LAC application determines the distribution of fans of each team throughout the venue by identifying the team colors of the clothes that users are wearing. The LAC application, in some embodiments, causes the device to capture an image of a user at the venue or receives an image of the user at the venue. In some implementations, the LAC application analyzes the image, e.g., using any suitable method for image processing, and determines which team the user is supporting. In some embodiments, the LAC application selects areas or regions of the venue to perform team-specific actions based on the distribution of fans of each team in the venue.

In some embodiments, the LAC application selects the visual effect based on the available devices and their locations. In some embodiments, the LAC application determines whether a device is in an active state, which indicates that the device is currently available to participate in output signals coordinated to form the visual effect, or an inactive state, which indicates that the device is not currently available to participate in output of signals to form the visual effect. In some embodiments, the determination of whether the device is in an active or an inactive state is based on monitoring the stability level of the device. For example, if a user has kept their device in their pocket while walking, the stability level of the device may indicate that the device is not stable and therefore in an inactive state. In some embodiments, the determination of whether the device is in an active or inactive state is based on a position of the device. For example, the LAC application, after determining that the device is located in the bathroom or at a concession stand, may determine that the device is not available to participate in output of signals to form the visual effect, and therefore assign a state of “inactive” to the device.

In some embodiments, the LAC application determines a density of a section or a particular area and select the visual effect based on the density. In some embodiments, the LAC application determines a number of devices associated with the active state that are concentrated within the section, and selects the visual effect based on the number of devices. For example, after determining that a particular section has a low concentration of devices associated with the active state, the LAC application might select a visual effect that does not have a very high pixel density or that does not require a high concentration of devices associated with the active state. In some embodiments, the LAC application searches for a section or region of the venue with the highest density of active devices and selects that section or region of the venue to display a visual effect.

In some embodiments, the LAC application selects the visual effect and modifies a resolution or a pixel density of the visual effect based on the density of the section. For example, the LAC application may select a type of visual effect (e.g., raster graphics, dot animation, or any other suitable content type) based on the density of the section. In some implementations, the visual effect may be a static image, a pattern, and/or a moving image (e.g., a Notre Dame leprechaun tipping his hat). In some embodiments, the LAC application may select a more complex visual effect (e.g., relatively more text animation and/or a relatively more intricate visual animation) when there is a higher density of active devices, while selecting a less complex visual effect when there is a lower density of active devices. In some embodiments, the LAC application selects a region to display a part of an animation based on the density of the region. As an example, the LAC application may select a region of the venue with a higher density of devices having opted in to participate with the visual effect, to form the outline of the visual effect.

In some embodiments, the LAC application determines a subset of the plurality of devices that are best suited for a given animation or pattern based on their capabilities (e.g., screen size, battery life, high resolution display, superior flashlight capabilities, and/or any other suitable device capabilities). For example, the LAC application may search for a section or area of the venue having opted in to participate with outputting the visual effect with the highest concentration of devices that meet the capabilities best suited for an visual effect, and select devices located in that section or area of the venue to display the visual effect. In some implementations, the LAC application may determine a density of devices with specific capabilities within a section or area of the venue and select the animation or pattern for output based on the density of devices with the specific capabilities. For example, the LAC application, in some embodiments, determines a density of devices with multi-color flash capabilities within a section of the venue. Based on determining that there is a high density of devices with multi-color capabilities located within the section of the venue, LAC application, in some embodiments, selects a visual effect that leverages the multi-color capabilities of devices within that section (e.g., by selecting an animation or pattern with flashing colors).

In some embodiments, the LAC application modifies which signals to output based on a characteristic of a user (e.g., which team they are a supporter of, or any other suitable characteristic) of the device. For example, the LAC application may, after determining that a user is a fan of the home team, modify the signals output by the device to correspond to home team colors. As another example, the LAC application, after selecting an animation that cheers on the away team, may not cause a device associated with a fan of the home team to output signals coordinated to form the animation that cheers on the away team. In some embodiments, the LAC application determines one or more characteristics of the mobile device, and modifies the output based on the characteristics of the mobile device. In one example, the LAC application determines a battery life of the mobile device and modifies the signals output by the mobile device based on the device's battery life. In another example, the LAC application determines an orientation of the mobile device, and determines the output to use based on the orientation of the mobile device.

In some embodiments, after 156, process 150 moves to step 158, where the LAC application causes the plurality of devices to output signals that together form selected animation 160 (e.g., “GO DAWGS!”). In some embodiments, the LAC application controls one or more of a video, audio, or haptic output of the plurality of devices via the LAC application. In some embodiments, the LAC application causes the signals forming the visual effect to be output via one or more of a flashlight, a screen or display, a speaker, or any other suitable output mechanism. In some implementations, the output signals are coordinated to form the visual effect such that the output signals from each device comprise one or more pixels of the visual effect. The LAC application, in some embodiments, causes audio to be output along with visual signals that are coordinated to form the visual effect.

In some embodiments, the signals that are coordinated to form the visual effect are output via a screen of the respective device, such that the screen of the respective device comprises one or more pixels of the visual effect. In some embodiments, the signals output by a singular device comprise a singular pixel of the visual effect displayed by the coordinated output such that the signals output by all the devices together form the larger visual effect. For example, in an animation formed by light output from the flashlight of each device of a plurality of devices, the light output by the flashlight of a singular device of the plurality of devices comprises a singular pixel of the larger animation, and the light output by all the devices together forms the larger animation.

In the example of FIG. 1C, the LAC application may cause animation 160 (“GO DAWGS!”) to be output by the plurality of identified devices. For example, “Go Dawgs!” may be output automatically (e.g., based on being preset by the home team for certain times during the game), based on input received from one or more users, based on a poll of such users, based on a number of users determined to have downloaded the LAC application or otherwise be willing to participate in the coordinated animation and their respective locations or positions within the venue, and/or based on any other suitable factor. To cause output of animation 160, the LAC application may determine, for each letter or character of “Go Dawgs,” a desired size of, a number of desired devices to be used in forming a boundary of, e.g., the letter G indicated at 162, and/or a desired location of each portion of the letter relative to other portions of the same letter and/or other letters, and/or any other suitable parameters. The LAC application may determine whether a sufficient number of devices are present in a section of the venue where G is being output or is to be output and whether such devices are in a suitable location to form the boundary for “G,” and each other character. In some embodiments, the venue may be mapped to a coordinate system (e.g., cartesian coordinate system or a point cloud or any other suitable coordinate system), and participating devices may be mapped to coordinates, to keep track of device locations and facilitate output of the animation and/or dynamic changes to such animation. In some embodiments, the LAC application may use feedback, e.g., obtained from users or obtained via a camera capturing an image of the “Go Dawgs!” animation 162, and analyze such image, to determine whether any additional devices should be added or removed from the animation to make the animation larger, smaller and/or more comprehensible.

In some examples, the LAC application may detect a change in the state of the device from the active state to the inactive state and modify the output of signals on the device based on the change. For example, if the LAC application causes all the devices determined to be in the active state to output signals part of the coordinated output, a device of a user who leaves to go to the concession stand may initially be part of the coordinated output. However, once the user begins moving towards the concession stand, in some embodiments, the LAC application, when tracking the current position of the device, may detect the movement of the user using, e.g., the techniques described herein in relation to determining the position of the device within the venue and recalibrating the device's position. In some embodiments, the LAC application determines that the device's state has changed from the active state to the inactive state due to the movement of the device towards the concession stand and stop the output of signals on the device due to the change in the device's status. In some embodiments, after determining that the state of the device has changed from the inactive state to the active state, the LAC application begins to output signals on a device and/or prompts the user to move their device to an appropriate position or in an appropriate manner to participate in a visual effect.

In some embodiments, the LAC application, rather than causing the devices at different positions in the venue to output signals making up different portions which together form a visual effect, may cause the plurality of devices to output the same signal. In one example, the LAC application may cause the plurality of devices to output the same color via screens of the plurality of devices. In another example, the LAC application causes the plurality of devices to output the same flickering pattern via flashlights of the plurality of devices. In some implementations, the LAC application causes the devices to output signals which together form a pattern. As an example, the LAC application might cause all the devices located in even-numbered seats to output the color purple via a screen of the device while causing all the devices located in the odd-numbered seats to output the color yellow via a screen of the device. In some embodiments, for devices participating in an animation, different output mechanisms may be employed, e.g., certain devices may output a portion of the animation using their screen, while other devices may output a portion of the animation using their flashlight.

In some implementations, the LAC application integrates the venue's lighting and sound systems into the displayed visual effect. For example, the LAC application may control one or more speakers, screens, or vibrators of the venue to create large-scale or immersive effects such as synchronized audio or visual waves. As another example, the servers 140, after selecting the visual effect, may cause screens within the venue to also output signals which, together with the signals being output from the plurality of devices, form the selected visual effect.

In some embodiments, when the live event comprises a performer's event such as a concert or show, the LAC application causes the output signals to be in sync with the performance. For example, at a concert, the LAC application may cause the output signals to be in sync with a song, rhythm, gesture, or orientation of a performer. In such an example, when the performer turns their head to the right, the servers might cause the devices located on the right side of the venue to output signals that are coordinated to form a particular animation or visual effect. In some embodiments, the LAC application modifies the signals output from a device based on which team a user of the device supports. For example, in some embodiments, when a team wins a point or a play otherwise has a positive outcome for a team, the LAC application causes the devices corresponding to fans of the team to light up to maximum brightness, plays a sound at a large volume, vibrate to maximum capability, and/or output any other suitable signals. In some implementations, the LAC application detects the audience's noise level or movements using the LAC application or using sensors within the venue, and modifies the visual effect based on the audience's noise level or movements. As an example, in some embodiments, the LAC application, after detecting that the audience is cheering very loudly, may increase the brightness of the visual effect by causing the coordinated signals output by the devices to increase in brightness.

In some embodiments, the LAC application dynamically adapts the displayed visual effect based on changes in the density of active devices. For example, in some embodiments, if a large group of spectators leave a section of the venue for which coordinated output of an animation is currently being caused, the LAC application detects a change in the density of the section of the venue and modifies the coordinated output to reflect the change. In some embodiments, the LAC application determines an updated density for an area of the venue based on detecting the change in the density and selects a different animation based on the updated density. The LAC application, in some embodiments, outputs the signals that are coordinated to form the different animation on devices specified as having the active state in association with the updated density in the section of the venue. In some implementations, the LAC application selects a less complex animation for coordinated output after detecting that the density of available devices has decreased, while in some embodiments, the LAC application selects a more complex animation for coordinated output after detecting that the density of available devices has increased.

In some implementations, if a large group of spectators leave a section of the venue for which coordinated output of the animation is currently being caused, the LAC application causes coordinated output of the animation to be implemented in a different section of the venue with a density more appropriate for the animation. In some embodiments, when the distribution of fans of each team located in a particular section of the venue changes over time, the LAC application detects the change in the distribution, and modifies the coordinated output based on the change. For example, if a large group of fans of the home team leave a particular section that was, prior to their exit, heavily concentrated with fans of the home team, the LAC application may redetermine a density of home team fans in that section. In some implementations, if the density of home team fans in that section dips below a threshold, the LAC application may modify or stop the coordinated output.

In some embodiments, the LAC application modifies the animation based on event or game conditions. In one example, the LAC application may identify when the away team is on offense, and coordinate visual and/or audible output of the words “Defense! Defense!” from the home team's section of the venue. As another example, the LAC application may identify when there is less than a minute left in the game and coordinate output cheering on the home team based on identifying that the game is almost over. As another example, the LAC application may, based on identifying that the opposing team is shooting a free throw, coordinate distracting visual and/or audible output to be displayed by the devices behind the backboard display.

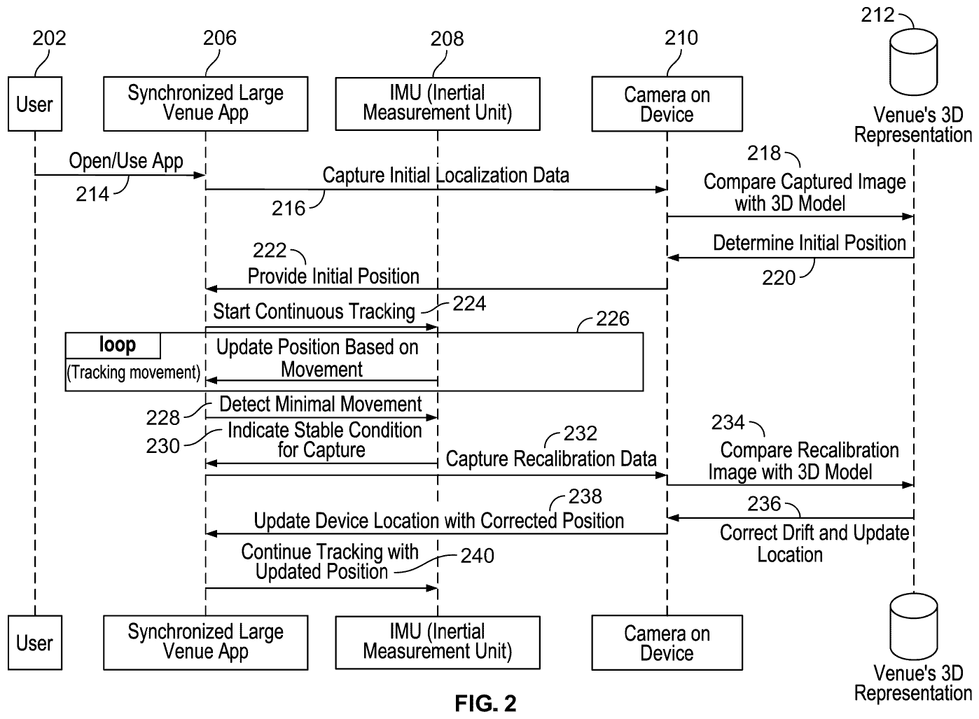

FIG. 2 shows an illustrative technique for tracking the precise location of a device, in accordance with embodiments of the disclosure. In some embodiments, the process of tracking the precise location of a device (e.g., device 104 of FIGS. 1A-1C) begins at step 214, when a user (e.g., user 202) opens a synchronized large venue app (e.g., synchronized large venue app 206, which in some embodiments, corresponds to the LAC application described in relation to FIGS. 1A-1C) on the device. In some embodiments, the synchronized large venue app, at step 216, engages a camera-based vision system, which causes a camera of the device (e.g., camera 210) to capture initial localization data. The device's camera, in some embodiments, captures the initial localization data by capturing an image or a video. In some implementations, at step 218, the camera-based vision system compares the captured image with the venue's 3D representation (e.g., 3D representation 212) to accurately localize the device within the complex spatial layout of the venue. At step 220, based on the comparison, in some embodiments, the camera-based vision system determines the initial position of the device, and at step 222, provides the initial position to the synchronized large venue app.

In some embodiments, once the initial position is established, at step 224, the synchronized large venue app instructs the inertial measurement unit (IMU) (e.g., IMU 208) of the device to begin continuous or intermittent tracking of the device's position. In some embodiments, the IMU comprises one or more accelerometers, gyroscopes, magnometers, or any other suitable sensors. The IMU, in some implementations, monitors the device's movement in terms of acceleration, rotational changes, and/or orientation, that allows for the tracking of the device's position in real time without the need for continuous visual input. In some embodiments, at step 226, the IMU executes a loop for tracking movement which updates the position of the device based on the device's tracked movements.

In some embodiments, at step 228, as the loop is being executed and the device's movement and position are being updated, the synchronized large venue app, while monitoring for minimal, or a relatively low level of, movement that indicates a stable condition for image capture, detects minimal movement. In some embodiments, at step 230, the synchronized large venue app receives data from the IMU that indicates that the device is stable enough for image capture (e.g., a condition for stability is met such as, for example, a stability level being above or below a threshold). In some implementations, at step 232, the synchronized large venue app re-engages the camera-based vision system, which causes the device's camera to capture recalibration data to help recalibrate the position of the device and correct any errors accumulated in the position data collected by the IMU. In some embodiments, the camera-based vision system causes the device's camera to capture the recalibration data by capturing an image or a video.

In some implementations, at step 234, the camera-based vision system compares the captured recalibration image with the venue's 3D representation to accurately localize the device within the complex spatial layout of the venue. Based on the comparison, in some embodiments, at step 236, the camera-based vision system corrects any drift or accumulated errors in the position of the device and updates the location of the device. In some implementations, at step 238, the synchronized large venue app receives the updated location and updates the device position with the corrected location. In some embodiments, at step 240, the synchronized large venue app instructs the IMU to continue tracking with the updated position. In some embodiments, the capture of recalibration data and the recalibration of the device's position based on the captured recalibration data continues either periodically or each time that the stable condition for capture of recalibration data is met.

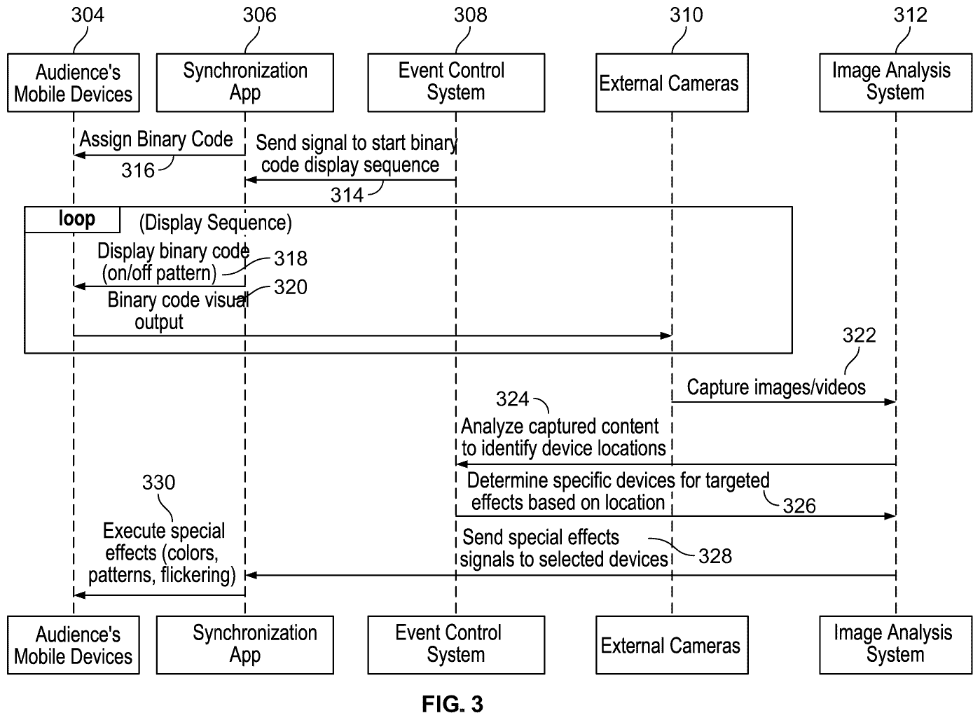

FIG. 3 shows an illustrative technique for identifying the precise location of a device and executing output of signals to form a visual effect, in accordance with embodiments of the disclosure. In some embodiments, the positions of devices at the venue (e.g., devices such as device 104 of FIGS. 1A-1C) are determined by leveraging external cameras (e.g., external cameras 310) used at the event. In some embodiments, the external cameras (which may correspond to cameras 131, 132, 134, 136 of FIG. 1A) are the professional cameras used for live broadcasting, while in some embodiments the external cameras are set up specifically for this purpose. In some embodiments, the following process is used to determine the initial location of the devices. In some embodiments, the following process is used to recalibrate the tracked position and movement of audience devices.

In some embodiments, at step 314, an event control system (e.g., event control system 308) sends a signal to the synchronization app (e.g., synchronization app 306, which in some embodiments corresponds to the synchronized large venue app 206 of FIG. 2) to start a binary code display sequence. At step 316, the synchronization app, in some implementations, assigns a binary code to the audience's mobile devices (e.g., audience mobile devices 304, which in some embodiments, correspond to devices such as device 104 of FIG. 1A-1C). In some embodiments, the binary code serves as a unique identifier for each device. As an example, the synchronization app may assign a device the code “1-0-1-0-1-1.” In some embodiments, the length of the binary code is much greater than the length of six used in the prior example. For example, the synchronization app may assign a 16-bit code to each device, which allows for the identification of up to 65,536 devices. In some embodiments, the event control system determines a number of devices within the venue and sets the length of the binary code assigned to each device based on the number of devices within the venue. In some embodiments, a message may be broadcast to devices in the venue, and devices may communicate their location or position in the venue with a response, e.g., Manchester encoding, flashing their screen or flashlight with a pattern or device identifier, which may be identified by the LAC application (e.g., using computer vision) to localize one or more devices in the venue.

At step 320, in some embodiments, the synchronization app causes the binary code to be displayed by causing the audience's mobile devices to display the binary code using a sequential on/off pattern. In some embodiments, the synchronization app causes the mobile device to output, via a screen or flashlight of the device, a sequence of signals such that the sequence of signals displayed by the mobile device represents the unique binary code assigned to the mobile device. In some embodiments, the output of the binary code on each audience device is coordinated, so that each device outputs the binary code display sequence at the same time. As an example, for a device assigned the simple binary code “1-0-1,” the synchronization app may cause the device's flashlight to sequentially turn on for a second, off for a second, and on again for another second.

In some implementations, the event control system sends signals to the synchronization app to begin the binary code display sequence only for a subset of the audience mobile devices in the venue. In some examples, the event control system sends a signal to the synchronization app to display the binary code sequence for a particular device.

In some embodiments, at step 322, one or more external cameras (e.g., external cameras 310) are used to capture the binary code visual output. The external cameras, in some examples, capture one or more images of the binary code visual output. In some embodiments, the external cameras capture a video of the binary code visual output. In some embodiments, the display of the binary code by the synchronization app and the capture of the binary code visual output are executed in a loop. For example, the synchronization app may cause the first digit in the binary code to be output on the mobile devices using the on/off pattern, and the external cameras may subsequently capture an image of the visual output on the mobile devices that represents the first digit. In such an example, after the image of the visual output on the mobile devices has been captured, the synchronization app may cause the second digit in the binary code to be output on the mobile devices using the on/off pattern, and the external cameras may subsequently capture an image of the visual output on the mobile devices that represents the second digit. In some examples, this process repeats for each digit in the binary code.

In some implementations, the external cameras send the captured images and/or videos of the visual output to an image analysis system (e.g., image analysis system 312). In some implementations, at step 324, the image analysis system analyzes the captured images to match the unique patterns displayed by the devices with their binary codes, thus determining the precise location of each device in the camera's view. In some embodiments, the precise location determined by the image analysis system is used to determine the initial location of each device prior to outputting signals coordinated to form a visual effect, e.g., using the techniques described in relation to FIGS. 1A-1C. In some embodiments, the determining of the initial location of a device is based at least in part on image analysis that identifies portions of the captured images that depict the unique patterns displayed by the devices with their binary codes.

Any suitable technique may be used to analyze the captured images/videos to determine the precise location of each device. For example, the image analysis system may employ machine learning and/or heuristic techniques in real time to analyze the captured image. In some embodiments, an image thresholding technique, an image segmentation technique, a computer vision technique, an image processing technique, or any other suitable technique, or any combination thereof may be used by the image analysis system. In some embodiments, the image analysis system may utilize one or more machine learning models (e.g., naive Bayes algorithm, logistic regression, recurrent neural network, convolutional neural network (CNN), bi-directional long short-term memory recurrent neural network model (LSTM-RNN), or any other suitable model, or any combination thereof) to localize and/or classify objects in a given image.

In some implementations, the image analysis system sends the precise locations of each device to the event control system. In some embodiments, at step 326, the event control system determines specific devices for targeted effects based on the device locations. For example, the event control system may determine which devices are located on the aisles of the venue based on the results received from the image analysis system and designate those devices to display a green color on their screens. In some embodiments, at step 328, the image analysis system sends special effects signals to the synchronization app. At step 330, the synchronization app, in some embodiments, executes the special effects (e.g., colors, patterns, flickering, etc.) on the selected devices, e.g., using the techniques described in relation to FIGS. 1A-1C.

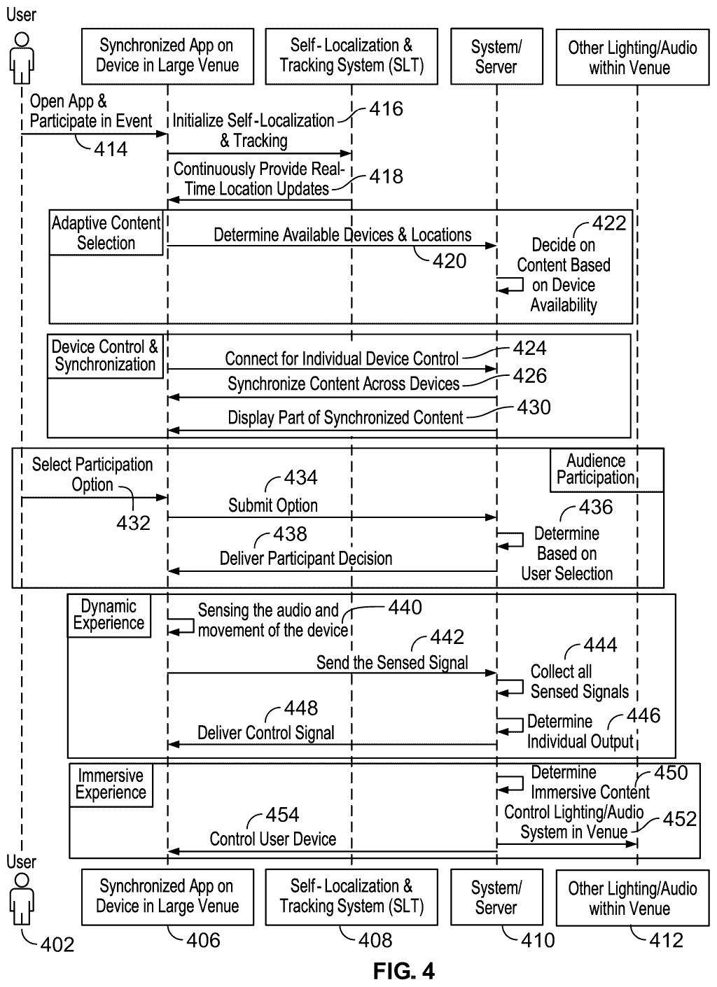

FIG. 4 shows an illustrative technique for causing coordinated output of an visual effect at a live event, in accordance with embodiments of the disclosure.

In some embodiments, at step 414, the process for causing coordinated output of a visual effect at a live event begins when a user (e.g., user 402) in a large venue opens a synchronized app (e.g., the synchronized app on device in large venue 406, which in some embodiments corresponds to synchronized app 206 of FIG. 2) downloaded on their device. In some embodiments, once a log in is detected, the synchronized app initializes various systems and features for enhanced event engagement. In some embodiments, the synchronized app determines a seat number corresponding to a user of the device and uses the seat number as an initial location estimate for the device.

In some embodiments, at step 416, the synchronized app initializes a self-localization and tracking system (e.g., self-localization and tracking system (SLT) 408). The SLT system, in some implementations, tracks the device's real time location within the venue. At step 418, in some embodiments, the SLT system uses the device's sensors to continuously update the synchronized app with the device's real-time location. In some implementations, the SLT system provides the synchronized app with information related to the device's orientation (e.g., the direction that the device is facing).

In some embodiments, at step 420, the synchronized app communicates with a system and/or server (e.g., system/server 410, which in some embodiments, corresponds to server 904 of FIG. 9) to report available devices and their locations. At step 422, in some embodiments, based on determining available devices and their locations, the system analyzes the data related to device availability and location to decide content to display based on the device availability. In some embodiments, the system decides on the specific content to be displayed or actions to be taken based on the layout of the venue and the composition of the audience. The system, in some implementations, adapts the content selection based on the distribution and availability of devices within the venue, e.g., based on the techniques described in relation to FIGS. 1A-1C.

In some implementations, at step 424, the synchronized app establishes a connection with the system, which enables the system to control output on each device. In some embodiments, at step 426, the system synchronizes the content across a plurality of devices by causing signals to be output via each device of the plurality of devices. At step 430, the system, in some embodiments, instructs the synchronized app on each device to cause the device to output a part (e.g., a pixel) of the synchronized content. In some embodiments, the signals are output by turning a flashlight of the device on or off, controlling a frequency of the on or off of the flashlight, controlling a luminance level of the flashlight, modifying a brightness of an LCD/OLED screen of the device, causing a color, images, or video to be displayed on the LED/OLED screen of the device, modifying an audio signal to be output by the device, modifying a vibrational signal amplitude, or using any other suitable method.

In some embodiments, the synchronization app prompts user input related to participation options (e.g., choosing a response to an event, voting, or any other suitable participation option). At step 432, the synchronization app, in some examples, receives user input selecting a participation option, and at step 434, submits the option to the system. In some implementations, the server receives user input related to participation options from a plurality of devices. At step 436, the system, in some implementations, processes the received user input to determine an action based on the received user input. At step 438, the system, in some embodiments, delivers the decision back to the synchronization app for feedback or for further interaction. For example, the system may decide to send the results of a poll back to the synchronization app, which may cause a user interface to be displayed on the device that prompts further user interactions. In some embodiments, the system modifies the coordinated output based on the received user input. For example, the system may receive user input voting for a player on the home team and modify the coordinated output to display an animation cheering on the player.

In some embodiments, the system receives user input related to the coordinated output. For example, the system may release a poll on the synchronized app requesting user input voting for an animation to display. As another example, the system may request that users enter text they wish to display across a particular section of the venue. In some embodiments, the system modifies the signals output on each device based on the responses received from the device. For example, the system may increase the brightness of a signal output from a device based on receiving user input via the device indicating a particular response while decreasing the brightness of a signal output from another device based on receiving user input via the device indicating an opposite response.

In some embodiments, the system processes the user input and decides on an action based on collective audience participation. In some implementations the system communicates the action to the synchronization app in order to receive further user inputs related to the action.

In some embodiments, at step 440, the synchronization app senses the audio and movement of the device, capturing the ambient environment within the venue or actions of a user corresponding to the device. As an example, in some embodiments, the synchronization app detects when the user is cheering loudly via the movement of the device and audio from the ambient environment (e.g., audio of the user's voice cheering). In some embodiments, at step 442, the synchronization app sends the sensed signals to the system, which at step 444 collects and analyzes the sensed signal data from all participating devices. In some embodiments, at step 446, the system determines the appropriate individual output for each device. At step 448, the system, in some implementations, sends control signals back to the synchronization app, instructing the synchronization app to cause specific actions or adjust the signals output from the device.

In some implementations, the system integrates the venue's lighting and audio systems (e.g., the other lighting/audio within the venue 412) into the coordinated output. At step 450, in some embodiments, the system selects immersive content and adapts the display based on the available devices and lighting/audio system capabilities. At step 452, the system, in some embodiments, directly controls the lighting and audio systems in the venue to synchronize with the coordinated output on the mobile devices. At step 454, in some embodiments, the system concurrently controls the output and functionalities of the mobile devices through the synchronization app.

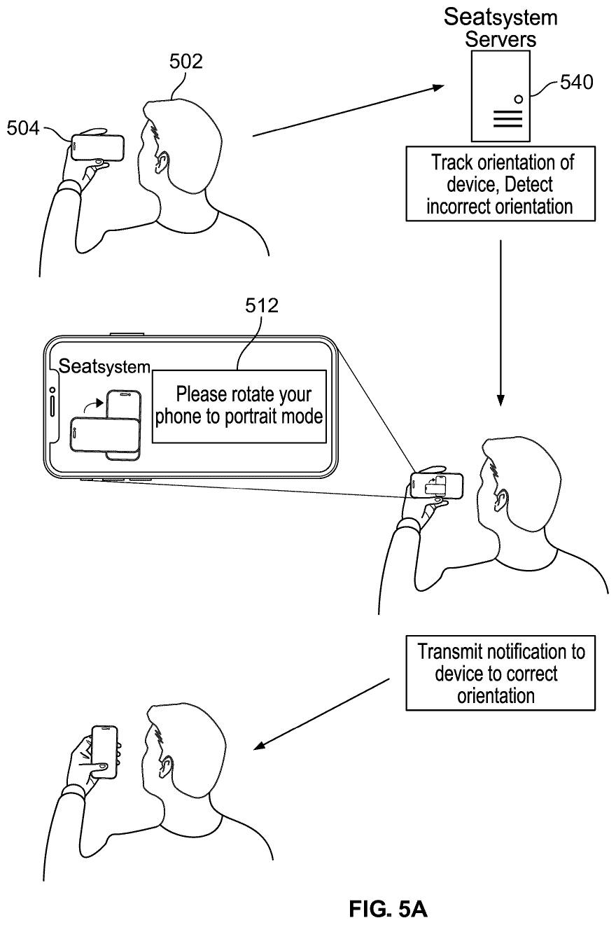

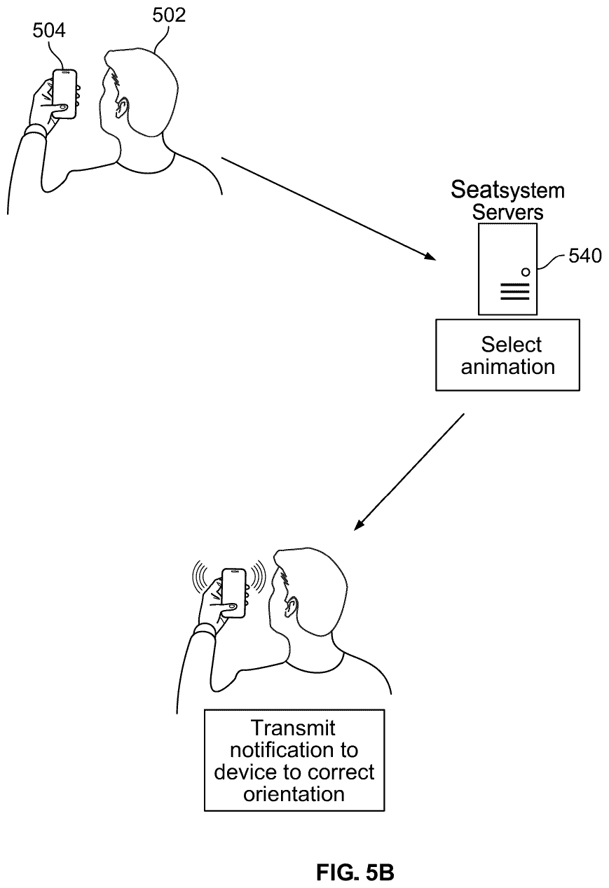

FIG. 5A is a schematic example of transmitting a notification to a device (e.g., device 104 of FIGS. 1A-1C) in relation to coordinated output of an animation, in accordance with embodiments of the disclosure. In some embodiments, an LAC application (e.g., the LAC application described in relation to FIGS. 1A-1C) transmits notifications to participating devices guiding them to position their devices in a particular manner best suited for the coordinated output.

In some embodiments, the LAC application provides detailed instructions that specify how to position, hold, or move the device (e.g., instructions to hold a flash of the device outwards, to hold a screen of the device outwards, to raise the device in the air, to wave the device from side to side, to move the device in clockwise circles, to move the device in a zig-zag manner, or any other suitable instructions related to the coordinated output) during the coordinated output. For example, the LAC application may transmit a notification to participating devices specifying that the device should be held around chest-level with the flash facing outwards. In some embodiments, the notifications are provided using any suitable notification method (e.g., by displaying the instructions on a screen of the device, via haptic feedback, by providing audio instructions through an earbud connected to the device, or using any other suitable notification method). In some embodiments, the LAC application determines whether or not each device is ready to participate in the coordinated output based on whether the device is following the output instructions. For example, the LAC application, after transmitting a notification to a device instructing that the device be held at eye-level, may determine that a device is ready to participate in the coordinated output based on determining that the device is currently held at eye-level. Conversely, in another example, the LAC application may, after transmitting a notification to a device instructing that the device be held at eye-level, determine that the device is not ready to participate in the coordinated output based on determining that the device is not being held at eye level.

As an example, as shown in FIG. 5A, user 502 is holding device 504, which is participating in coordinated output of the animation, in a landscape orientation. In some embodiments, device 504 corresponds to device 104 of FIGS. 1A-1C. In the example of FIG. 5A, servers 540 of the LAC application, which in some embodiments correspond to servers 140 of FIGS. 1A-1C, detect that user 502 is holding the device in an incorrect orientation.

In some embodiments, the LAC application determines that a device is held in an incorrect manner based on the signals chosen for output on the device. For example, the LAC application may choose to output signals via a screen of the device, but a user may be holding the device with the flashlight facing the stage and the screen facing themselves. In such a scenario, in some embodiments, the LAC application transmits a notification to the device instructing the user to turn the phone around such that the screen of the device is facing the stage. In some embodiments, the notification is transmitted via one or more of an on-screen message, haptic feedback, audio output, or any other suitable notification method. In the example of FIG. 5A, the LAC application, after detecting that user 502 is holding the device 504 in an incorrect orientation, transmits on-screen message 512 to device 504, instructing the user to rotate their phone to portrait mode to correct the device's orientation.

FIG. 5B is a schematic example of transmitting a notification to a device in relation to coordinated output of an animation, in accordance with embodiments of the disclosure.

In some implementations, the LAC application transmits a notification to the device in the form of haptic feedback. In the example of FIG. 5B, LAC application selects an animation to display as part of the coordinated output. The LAC application, after selecting an animation for coordinated output, transmits a notification to device 504 via haptic feedback to change the orientation of the device.

In some embodiments, the LAC application may instruct users of devices participating in the coordinated output to change the way that they are holding or moving the device via directional haptics (e.g., on the left, right, top, or bottom sides of the display). In the example of FIG. 5B, the LAC application, in order to instruct device 504 to turn the phone to the right, may cause a sensation that the right side of device 504 is vibrating, thus indicating that the device should be turned to the right. In some embodiments, the LAC application transmits the haptic feedback along with an on-screen message or audio output.

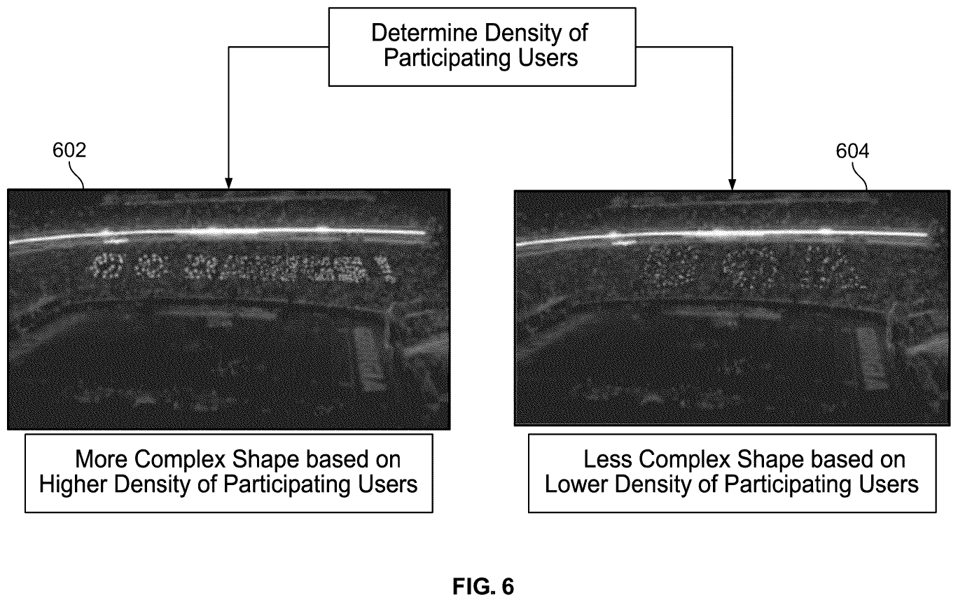

FIG. 6 is a schematic illustration of modifying the density of an animation at a live event, in accordance with embodiments of the disclosure.

In some embodiments, an LAC application (e.g., the LAC application described in relation to FIGS. 1A-1C) determines a density of participating users within the venue. In some implementations, the LAC application determines which devices within the venue are available to participate in the coordinated output.

In some embodiments, the LAC application selects a more complex animation for coordinated output based on determining a higher density of participating users. For example, as shown in example 602, the LAC application, based on determining a higher density of participating users, chooses a more complex coordinated display that spells out the words “GO DAWGS” across a region of the venue. In some embodiments, the LAC application chooses the animation based on the locations of the participating users. For example, in some embodiments, if there are more users concentrated across the middle of a section, the LAC application does not choose an animation with a border that would require participation from individuals located near the edges of the region.

In some implementations, the LAC application selects a less complex animation for coordinated output based on determining a lower density of participating users. For example, as shown in example 604, the LAC application, based on determining a lower density of participating users, chooses a less complex coordinated display that spells out “UGA” across a region of the venue. In some embodiments, if the LAC application determines that the participating devices within a region are particularly scattered, the LAC application transmits a notification to some of the participating devices to move towards a particular area within the venue.

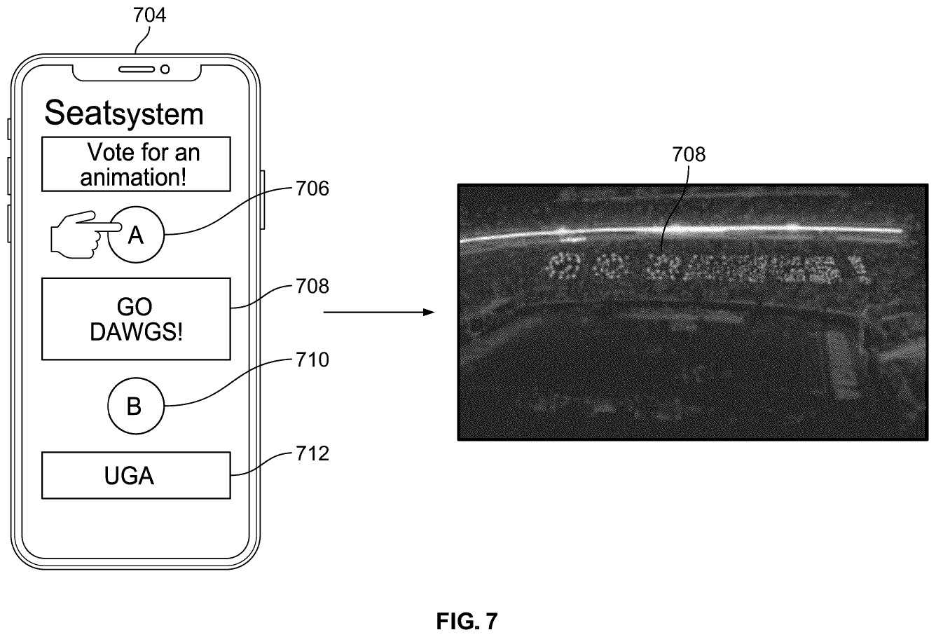

FIG. 7 is a schematic illustration of causing coordinated output of an animation at a live event based on received user inputs, in accordance with embodiments of the disclosure.

As an example, in some embodiments, an LAC application (e.g., the LAC application described in relation to FIGS. 1A-1C) causes device 704 (which, in some embodiments, corresponds to device 104 of FIGS. 1A-1C) to display a user interface requesting user input related to coordinated output of the animation. In some implementations, the LAC application requests input from each device voting for the next animation or message to be displayed. In some embodiments, the LAC application, during a sports game, requests input from each device voting for one of the teams or for particular players. The LAC application, in some examples, modifies the coordinated output based on the received input. For example, if the LAC application receives more user inputs voting for the home team, the LAC application selects an animation related to the home team for the coordinated output. As another example, if the LAC application receives many user inputs voting for a particular player, the LAC application selects an animation related to the particular player for the coordinated output. In some embodiments, the LAC application, during a concert or performance, requests input from each device voting for a band member or a particular song, and selects the animation based on the received user inputs.

As an example, the LAC application causes device 704 to display, on the user interface, an option allowing users to vote for the next animation or message to be displayed by the coordinated output. The device causes selectable options 706 and 710 to be displayed, which correspond to messages 708 and 712, respectively. The device receives a selection of selectable option 706, which corresponds to the message that spells out the words “GO DAWGS!” In some embodiments, the LAC application receives the selection from device 704, and based on responses received from other devices, selects an animation for coordinated output. In some embodiments, based on receiving more votes for message 708, the LAC application selects message 708 for coordinated output and causes the message “GO DAWGS!” to be displayed across a plurality of participating devices.

FIGS. 8-9 describe illustrative devices, systems, servers, and related hardware for providing audio from a live event to a user, in accordance with some embodiments of the present disclosure. FIG. 8 shows generalized embodiments of illustrative user equipment 800, which may correspond to, e.g., user equipment 104 of FIGS. 1A-1C or audience mobile devices 304 of FIG. 3. For example, user equipment 800 may be a smartphone device, a tablet, a near-eye display device, an XR device, or any other suitable device. User equipment 800 may be communicatively connected to microphone 817, audio output equipment (e.g., speaker 816 or headphones 814), and display 812. In some embodiments, microphone 817 may receive audio corresponding to a voice of one or more audience members and/or ambient audio data during a live event. In some embodiments, display 812 may be an XR display or a computer display. In some embodiments, user input interface 810 may be a remote-control device. More specific implementations of user equipment are discussed below in connection with FIG. 7. In some embodiments, device 800 may comprise any suitable number of sensors (e.g., gyroscope or gyrometer, or accelerometer, etc.), and/or a GPS module (e.g., in communication with one or more servers and/or cell towers and/or satellites) to ascertain a location of device 800. In some embodiments, device 800 comprises a rechargeable battery that is configured to provide power to the components of the device.

User equipment 800 may receive content and data via input/output (I/O) path 802. I/O path 802 may provide content (e.g., internet content, content available over a local area network (LAN) or wide area network (WAN), and/or other content) and data to control circuitry 804, which may comprise processing circuitry 806 and storage 808. Control circuitry 804 may be used to send and receive commands, requests, and other suitable data using I/O path 802, which may comprise I/O circuitry. I/O path 802 may connect control circuitry 804 (and specifically processing circuitry 806) to one or more communications paths (described below). I/O functions may be provided by one or more of these communications paths but are shown as a single path in FIG. 8 to avoid overcomplicating the drawing. Mobile device 800 is shown in FIG. 8 for illustration, any suitable computing device having processing circuitry, control circuitry, and storage may be used in accordance with the present disclosure. For example, mobile device 800 may be replaced by, or complemented by, a personal computer (e.g., a notebook, a laptop, a desktop), a tablet, an XR device, a network-based server hosting a user-accessible client device, a non-user-owned device, any other suitable device, or any combination thereof.

Control circuitry 804 may be based on any suitable control circuitry such as processing circuitry 806. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 804 executes instructions for the LAC application stored in memory (e.g., storage 808). Specifically, control circuitry 804 may be instructed by the LAC application to perform the functions discussed above and below. In some implementations, processing or actions performed by control circuitry 804 may be based on instructions received from the media application.

In client/server-based embodiments, control circuitry 804 may include communications circuitry suitable for communicating with a server or other networks or servers. The LAC application may be a stand-alone application implemented on a device or a server. The LAC application may be implemented as software or a set of executable instructions. The instructions for performing any of the embodiments discussed herein of the LAC application may be encoded on non-transitory computer-readable media (e.g., a hard drive, random-access memory on a DRAM integrated circuit, read-only memory on a BLU-RAY disk, etc.). For example, in FIG. 8, the instructions may be stored in storage 808, and executed by control circuitry 804 of a device 800.

In some embodiments, the LAC application may be a client/server application where only the client application resides on device 800, and a server application resides on an external server (e.g., server 904 and/or media content source 902). For example, the LAC application may be implemented partially as a client application on control circuitry 804 of device 800 and partially on server 904 as a server application running on control circuitry 911. Server 904 may be a part of a local area network with one or more devices such as device 800 or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 904 and/or an edge computing device), referred to as “the cloud.” Device 800 may be a cloud client that relies on the cloud computing capabilities from server 904 to generate personalized engagement options in a VR environment. The client application may instruct control circuitry 804 to generate personalized engagement options in a VR environment.

Control circuitry 804 may include communications circuitry suitable for communicating with a server, edge computing systems and devices, a table or database server, or other networks or servers. The instructions for carrying out the above mentioned functionality may be stored on a server (which is described in more detail in connection with FIG. 9). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the internet or any other suitable communication networks or paths (which is described in more detail in connection with FIG. 9). In addition, communications circuitry may include circuitry that enables peer-to-peer communication of user equipment, or communication of user equipment in locations remote from each other (described in more detail below).

Memory may be an electronic storage device provided as storage 808 that is part of control circuitry 804. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 808 may be used to store various types of content described herein as well as the LAC application data described above. Nonvolatile memory may also be used (e.g., to launch a boot-up routine and other instructions). Cloud-based storage, described in relation to FIG. 8, may be used to supplement storage 808 or instead of storage 808.

Control circuitry 804 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 804 may also include scaler circuitry for upconverting and down converting content into the preferred output format of user equipment 800. Control circuitry 804 may also include digital-to-analog converter circuitry and analog-to-digital converter circuitry for converting between digital and analog signals. The tuning and encoding circuitry may be used by user equipment 800 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 808 is provided as a separate device from user equipment 800, the tuning and encoding circuitry (including multiple tuners) may be associated with storage 808.

Control circuitry 804 may receive instruction from a user by way of user input interface 810. User input interface 810 may be any suitable user interface, such as a remote control, mouse, trackball, keypad, keyboard, touch screen, touchpad, stylus input, joystick, voice recognition interface, or other user input interfaces. Display 812 may be provided as a stand-alone device or integrated with other elements of user equipment 800. For example, display 812 may be a touchscreen or touch-sensitive display. In such circumstances, user input interface 810 may be integrated with or combined with display 812. In some embodiments, user input interface 810 includes a remote-control device having one or more microphones, buttons, keypads, or any other components configured to receive user input or combinations thereof. For example, user input interface 810 may include a handheld remote-control device having an alphanumeric keypad and option buttons. In a further example, user input interface 810 may include a handheld remote-control device having a microphone and control circuitry configured to receive and identify voice commands and transmit information.

Audio output equipment 814 may be integrated with or combined with display 812. Display 812 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 812. Audio output equipment 814 may be provided as integrated with other elements of device 800 or may be stand-alone units. An audio component of videos and other content displayed on display 812 may be played through speakers (or headphones) of audio output equipment 814. In some embodiments, audio may be distributed to a receiver (not shown), which processes and outputs the audio via speakers of audio output equipment 814. In some embodiments, for example, control circuitry 804 is configured to provide audio cues to a user, or other audio feedback to a user, using speakers of audio output equipment 814. There may be a separate microphone 817 or audio output equipment 814 may include a microphone configured to receive audio input such as voice commands or speech. For example, a user may speak letters or words that are received by the microphone and converted to text by control circuitry 804. In a further example, a user may voice commands that are received by a microphone and recognized by control circuitry 804. Camera 818 may be any suitable video camera integrated with the equipment or externally connected. Camera 818 may be a digital camera comprising a charge-coupled device (CCD) and/or a complementary metal-oxide semiconductor (CMOS) image sensor. Camera 818 may be an analog camera that converts to digital images via a video card.

The LAC application may be implemented using any suitable architecture. For example, it may be a stand-alone application wholly implemented on user equipment 800. In such an approach, instructions of the application may be stored locally (e.g., in storage 808), and data for use by the application is downloaded on a periodic basis (e.g., from an out-of-band feed, from an internet resource, or using another suitable approach). Control circuitry 804 may retrieve instructions of the application from storage 808 and process the instructions to provide video conferencing functionality and generate any of the displays discussed herein. Based on the processed instructions, control circuitry 804 may determine what action to perform when input is received from user input interface 810. For example, movement of a cursor on a display up/down may be indicated by the processed instructions when user input interface 810 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 804 may allow a user to provide user profile information or may automatically compile user profile information. For example, control circuitry 804 may access and monitor network data, video data, audio data, processing data, participation data from a conference participant profile. Control circuitry 804 may obtain all or part of other user profiles that are related to a particular user (e.g., via social media networks), and/or obtain information about the user from other sources that control circuitry 804 may access. As a result, a user can be provided with a unified experience across the user's different devices.

In some embodiments, the LAC application is a client/server-based application. Data for use by a thick or thin client implemented on user equipment 800 may be retrieved on-demand by issuing requests to a server remote to user equipment 800. For example, the remote server may store the instructions for the application in a storage device. The remote server may process the stored instructions using circuitry (e.g., control circuitry 804) and generate the displays discussed above and below. The client device may receive the displays generated by the remote server and may display the content of the displays locally on device 800. This way, the processing of the instructions is performed remotely by the server while the resulting displays (e.g., that may include text, a keyboard, or other visuals) are provided locally on device 800. Device 800 may receive inputs from the user via input interface 810 and transmit those inputs to the remote server for processing and generating the corresponding displays. For example, device 800 may transmit a communication to the remote server indicating that an up/down button was selected via input interface 810. The remote server may process instructions in accordance with that input and generate a display of the application corresponding to the input (e.g., a display that moves a cursor up/down). The generated display is then transmitted to device 800 for presentation to the user.

In some embodiments, the LAC application may be downloaded and interpreted or otherwise run by an interpreter or virtual machine (run by control circuitry 804). In some embodiments, the LAC application may be encoded in the ETV Binary Interchange Format (EBIF), received by control circuitry 804 as part of a suitable feed, and interpreted by a user agent running on control circuitry 804. For example, the LAC application may be an EBIF application. In some embodiments, the LAC application may be defined by a series of JAVA-based files that are received and run by a local virtual machine or other suitable middleware executed by control circuitry 804. In some of such embodiments (e.g., those employing MPEG-2, MPEG-4, HEVC or any other suitable digital media encoding schemes), the LAC application may be, for example, encoded and transmitted in an MPEG-2 object carousel with the MPEG audio and video packets of a program.

As shown in FIG. 9, user equipment 906, 908, 910 (which may correspond to, e.g., user equipment 104 of FIGS. 1A-1B or user equipment 304 of FIG. 3) may be coupled to communication network 909. Communication network 909 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 909) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 7 to avoid overcomplicating the drawing.

Although communications paths are not drawn between user equipment, these devices may communicate directly with each other via communications paths as well as other short-range, point-to-point communications paths, such as USB cables, IEEE 1394 cables, wireless paths (e.g., Bluetooth, infrared, IEEE 902-11x, etc.), or other short-range communication via wired or wireless paths. The user equipment may also communicate with each other directly through an indirect path via communication network 909.

System 900 may comprise media content source 902, one or more servers 904, and/or one or more edge computing devices. In some embodiments, the LAC application may be executed at one or more of control circuitry 911 of server 904 (and/or control circuitry of user equipment 906, 908, 910 and/or control circuitry of one or more edge computing devices). In some embodiments, the media content source and/or server 904 may be configured to host or otherwise facilitate video communication sessions between user equipment 906, 908, 910 and/or any other suitable user equipment, and/or host or otherwise be in communication (e.g., over network 909) with one or more social network services.

In some embodiments, server 904 may include control circuitry 911 and storage 914 (e.g., RAM, ROM, Hard Disk, Removable Disk, etc.). Storage 914 may store one or more databases. Server 904 may also include an I/O path 912. I/O path 912 may provide video conferencing data, device information, or other data, over a local area network (LAN) or wide area network (WAN), and/or other content and data to control circuitry 911, which may include processing circuitry, and storage 914. Control circuitry 911 may be used to send and receive commands, requests, and other suitable data using I/O path 912, which may comprise I/O circuitry. I/O path 912 may connect control circuitry 911 (and specifically control circuitry) to one or more communications paths.

Control circuitry 911 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 911 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 911 executes instructions for an emulation system application stored in memory (e.g., the storage 914). Memory may be an electronic storage device provided as storage 914 that is part of control circuitry 911.

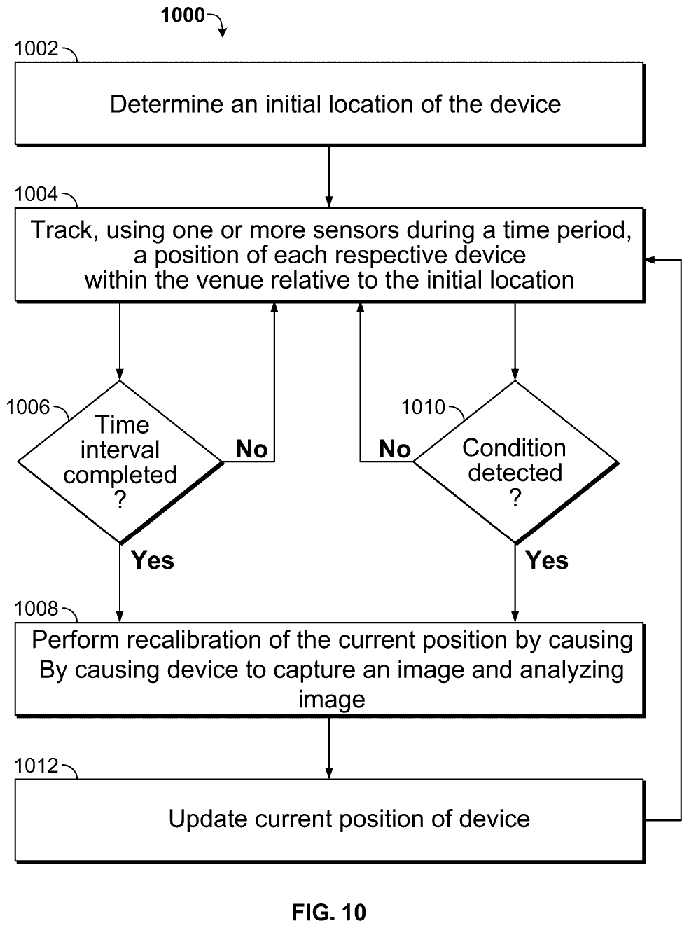

FIG. 10 is a flowchart of a detailed illustrative process for tracking the precise location of a device, in accordance with some embodiments of this disclosure.

Process 1000 begins at step 1002, where the control circuitry (e.g., control circuitry 804 of FIG. 8, or control circuitry 911 of FIG. 9) determines an initial location of the device. In some embodiments, control circuitry receives, from a camera (e.g., camera 818 of FIG. 8), one or more images (e.g., image 142 of FIG. 1B). The control circuitry, in some embodiments, analyzes the one or more images to determine the initial location of the device. In some embodiments, the control circuitry sends the one or more images to one or more servers (e.g., server 904 of FIG. 9) via input/output circuitry (e.g., I/O circuitry 802 of FIG. 8). In some implementations, the control circuitry determines an initial location of the device based on a seat number corresponding to a user of the device.

Process 1000 continues at step 1004, where the control circuitry tracks a position of the respective device (e.g., device 104 of FIGS. 1A-1C) within the venue relative to the initial location. In some embodiments, the control circuitry receives data from one or more sensors related to the device's orientation, movements, rotational changes, and acceleration. The control circuitry, in some implementations, uses the received data to track the position of the device with respect to the initial location.

Process 1000 continues at step 1006 and/or step 1010, where the control circuitry determines whether a time interval has been completed or whether a condition has been detected (e.g., a stability level is above or below a threshold, an acceleration is within a range, or any other suitable condition), respectively. If the control circuitry determines that a time interval (e.g., 30 seconds, one minute, five minutes, or any other suitable time interval) has been completed or that a condition has been detected, the process 1000 moves to step 1008, where the control circuitry performs recalibration of the current position by causing the device to capture an image and analyzing the captured image. If the control circuitry determines that a time interval has not been completed and a condition has not been detected, the process stays at step 1004, where the control circuitry continues to track, using data from one or more sensors during a time period, a position of each respective device within the venue relative to the initial location.

After the control circuitry performs recalibration of the current position by causing the device to capture an image and analyzing the image, the process 1000 continues at step 1012, where the control circuitry updates the current position of the device.

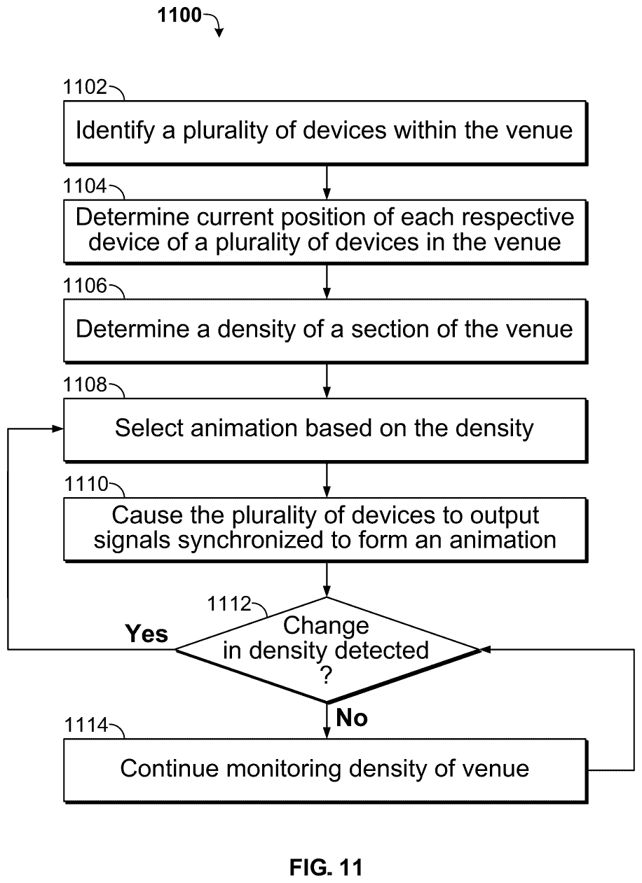

FIG. 11 is a flowchart of a detailed illustrative process for causing coordinated output of an animation at a live event, in accordance with some embodiments of this disclosure.

Process 1100 begins at step 1102, where the control circuitry (e.g., control circuitry 804 of FIG. 8, or control circuitry 911 of FIG. 9) identifies a plurality of devices (e.g., plurality of devices 164 of FIG. 1C) within the venue (e.g., venue 100 of FIGS. 1A-1C). The process continues at step 1104, where the control circuitry determines the current position of each respective device (e.g., device 104 of FIGS. 1A-1C) of the plurality of devices. At step 1106, the control circuitry determines a density of a section of the venue. In some embodiments, the control circuitry determines a state corresponding to each respective device which indicates whether or not the respective device is available to participate in the coordinated output. In some embodiments, the control circuitry determines the density of the section based on the states corresponding to each device located in the section.

At step 1108, the control circuitry selects an animation (e.g., animation 160 of FIG. 1C) based on the density. In some embodiments, the control circuitry selects a more complex animation based on a higher density of devices available to participate in the coordinated output, while in some embodiments, the control circuitry selects a less complex animation based on a lower density of devices available to participate in the coordinated output.

At step 1110, the control circuitry causes the plurality of devices to output signals synchronized to form the animation. The process 1100 moves to step 1112, where the control circuitry determines whether a change in the density has been detected. If the control circuitry determines that there has been a change in the density, the process moves back to step 1108, where the control circuitry selects another animation based on the changed density. If the control circuitry determines that there has been no change in the density, the process continues at step 1114, where the control circuitry continues to monitor the density of the venue. In some embodiments, the control circuitry continues to check for changes in the density of the section.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
identifying a plurality of devices at a live event;
determining, for each respective device of the plurality of devices at the live event, a current position of the respective device within a venue of the live event by:
determining an initial position of the respective device; and
tracking, using data from one or more sensors, a position of the respective device within the venue relative to the initial position;
performing recalibration of the current position by causing the respective device to capture an image, and analyzing the captured image; and
based on the determined current positions of the plurality of devices, causing the plurality of devices to output signals that are coordinated to form a visual effect.

2. The method of claim 1, wherein the identifying the plurality of devices at the live event further comprises:
receiving, from the plurality of devices, a user interface input requesting to participate in the coordinated visual effect.

3. The method of claim 1, wherein the signals that are coordinated to form the visual effect are caused to be output via a flashlight of the respective device.

4. The method of claim 1, wherein the signals that are coordinated to form the visual effect are caused to be output via a screen of the respective device such that the screen of the respective device provides one or more pixels of the visual effect.

5. The method of claim 4, wherein:
performing the recalibration further comprises causing at least a first device and a second device of the plurality of devices to communicate via peer-to-peer communication, to identify a current position of the first device relative to a current position of the second device; and
causing the plurality of devices to output the signals that are coordinated to form the visual effect by causing the screen of the respective device to correspond to one or more pixels of the visual effect is based at least in part on the current position of the first device relative to a current position of the second device.

6. The method of claim 1, further comprising causing the plurality of devices to output audio along with the signals that are coordinated to form the visual effect.

7. The method of claim 1, wherein the captured image is a first captured image, and determining the initial position of the respective device further comprises:
causing the respective device to capture a second image of at least a portion of the venue of the live event;
comparing the second image to a spatial representation of the venue; and
determining the initial position of the respective device based on the comparison.

8. The method of claim 1, wherein the tracking the position of the respective device relative to the initial position further comprises:
tracking changes in at least one of an acceleration, a rotational position, or an orientation of the respective device.

9. The method of claim 1, wherein:
the analyzing the captured image further comprises comparing the captured image to a spatial representation of the venue; and
the performing the recalibration of the current position includes updating the current position of the respective device within the venue of the live event based on the comparison.

10. The method of claim 1, wherein the performing recalibration of the current position by causing the respective device to capture the image further comprises:
monitoring a stability level of the respective device, wherein the stability level is based on at least one of an acceleration, a rotational position, or an orientation of the respective device;
determining that the stability level indicates that the device is stable; and
causing the respective device to capture the image based on determining that the stability level of the respective device indicates that the device is stable.

11. The method of claim 1, wherein the causing the plurality of devices to output the signals that are coordinated to form the visual effect further comprises:
monitoring a stability level of the respective device, wherein the stability level is based on at least one of an acceleration, a rotational position, or an orientation of the respective device; and
based on the monitoring of the stability level, determining whether the respective device is in an active state or an inactive state, wherein the active state indicates that the respective device is currently available to output the signals, and wherein an inactive state indicates that the respective device is currently unavailable to participate in output of the signals that are coordinated to form the visual effect.

12. The method of claim 11, wherein the causing the plurality of devices to output the signals that are coordinated to form the visual effect further comprises:
determining a density of a section of the venue, wherein the density specifies a number of devices associated with the active state that are concentrated within the section of the venue; and
selecting the visual effect based on the density.

13. The method of claim 12 further comprising:
based on detecting a change in the density of the section of the venue, determining an updated density for the section of the venue;
selecting a different visual effect based on the updated density; and
outputting, on devices specified as having the active state in association with the updated density in the section of the venue, signals that are coordinated to form the different visual effect.

14. The method of claim 13, further comprising:
based on determining that the respective device has changed from the active state to the inactive state, transmitting a notification to the respective device prompting the at least one device to participate in output of the signals that are coordinated to form the visual effect.

15. The method of claim 1, further comprising:
outputting, at the respective device, an indication directing a user to position or move the respective device in a particular manner to form the visual effect.

16. The method of claim 1, further comprising:
determining a characteristic corresponding to a user of the respective device; and
modifying the signals outputted by the respective device based on the determined characteristic.

17. The method of claim 1, wherein:
the plurality of devices are associated with a plurality of spectators at the venue;
one or more cameras in the venue are configured to capture a plurality of images of the plurality of spectators; and
determining the initial position of the respective device further comprises:
causing the respective device to output an initial output, wherein the initial output comprises a pattern unique to the respective device;
identifying portions of the plurality of images which depict the initial output; and
determining the initial position of the respective device with respect to the plurality of devices based at least in part on the portions of the plurality of images which depict the initial output.

18. The method of claim 1, further comprising:
identifying device capabilities corresponding to the respective device; and
selecting the signals to output on the respective device based on the device capabilities corresponding to the respective device.

19. (canceled)

20. A method performed by a server, the method comprising:
receiving, by the server, indications from a plurality of devices at a live event;
determining, by the server and for each respective device of the plurality of devices at the live event, a current position of the respective device within a venue of the live event by:
determining, by the server based on data received from the plurality of devices, an initial position of the respective device; and
tracking, based on data from one or more sensors received by the server from the plurality of devices, a position of the respective device within the venue relative to the initial position;
performing recalibration of the current position by transmitting an indication to the respective device to capture an image, and analyzing, by the server, the captured image; and
based on the determined current positions of the plurality of devices, transmitting indications to the plurality of devices to output signals that are coordinated to form a visual effect.

21. A system comprising:
a memory;
a control circuitry configured to:
identify a plurality of devices at a live event;
determine, for each respective device of the plurality of devices at the live event, a current position of the respective device within a venue of the live event by:
determining an initial position of the respective device; and
tracking, using data from one or more sensors, a position of the respective device within the venue relative to the initial position;
perform recalibration of the current position by causing the respective device to capture an image, and analyzing the captured image; and
based on the determined current positions of the plurality of devices, cause the plurality of devices to output signals that are coordinated to form a visual effect.

22-96. (canceled)
